(19) United States
(12) Patent Application Publication
(10) Pub. No.: US 2026/0077533 A1
(43) Pub. Date: Mar. 19, 2026

(54) APPARATUS FOR CUTTING WITH A CUTTING DEVICE

(71) Applicant: ARNEY 2015 VENTURES CORPORATION, Salt Spring Island (CA)

(72) Inventors: Donald Brian ARNEY, Salt Spring Island (CA); Peter Leighton BROOKE, Ladysmith (CA); Marcel Myette PENNINGTON, Penticton (CA); Brian Daniel STOLLE, Penticton (CA)

(73) Assignee: ARNEY 2015 VENTURES CORPORATION, Salt Spring Island (CA)

(21) Appl. No.: 19/335,897

(22) Filed: Sep. 22, 2025

Related U.S. Application Data
(63) Continuation-in-part of application No. PCT/CA2024/050355, filed on Mar. 22, 2024.
(60) Provisional application No. 63/453,998, filed on Mar. 22, 2023.
(60) Provisional application No. 63/514,479, filed on Jul. 19, 2023.

(51) Int. Cl. B27B 17/00; B27B 17/02

(52) U.S. Cl. CPC B27B 17/0083; B27B 17/02

(57) ABSTRACT

A kit, apparatus, and system for cutting an object. An arm is coupled to a cutting device, defining a cutting edge, to be resiliently rotatable away from the cutting edge. The arm is biased in an open position. In the open position, the arm is angled away from the cutting edge to define, between the cutting edge and the arm, an expandable opening that is suitable to receive the object and to expand by pushing of the object on to the arm to rotate the arm away from the cutting edge as the object is drawn into the opening to urge the object against the cutting edge.

### CROSS-REFERENCE TO RELATED APPLICATIONS

This application claims the benefit of U.S. Provisional Application No. 63/453,998, filed on 22 Mar. 2023, U.S. Provisional Application No. 63/514,479 filed on 19 Jul. 2023, and is a continuation in part of PCT International Application No. PCT/CA2024/050355 filed on 22 Mar. 2024.

Each of the aforementioned applications is incorporated by reference herein in its entirety, and each is hereby expressly made a part of this specification.

### TECHNICAL FIELD

The disclosure relates generally to attachments for cutting devices and cutting devices with attachments, and more particularly to a system, apparatus, and kit for cutting objects using cutting devices such as chainsaws and brush cutters.

### BACKGROUND

Cutting of trees and foliage is currently performed directly by hand or by aerially suspended cutters that are not always suitable for precision cutting, e.g. for cutting certain branches in a tree and not others adjacent thereto. Cutting branches using rods or booms can be challenging because of the need to apply sufficient force and for accurate positioning.

U.S. Pat. No. 4,294,012 discloses an arm assembly that can be retained in a closed position by means of a detent that locks the arm in position by a spring-loaded cotter pin. The arm is released for free movement by disengaging the spring-loaded cotter pin from the arm assembly.

U.S. Pat. No. 8,863,629 B2 discloses a cutting fixture for cutting pipes to facilitate attachment of a cutting element to a pipe, e.g. to facilitate a miter cut, or another desired cut. The cutting fixture includes two stabilizing elements that are configured to removably couple to the pipe by selectively engaging in a clamping manner and that are secured in place by a set screw, ratchet, or spring-loaded assemblies. The cutting system mount is configured to facilitate attachment of the cutting element to the fixture and provide an axis of rotation for the cutting element.

U.S. Pat. No. 3,834,019 discloses an apparatus for cutting through exhaust system components, such as tubes. The apparatus includes a tub engaging structure positioned to rotate towards a saw blade and that is configured to receive a tube for cutting in a tube receiving recess. A coil spring is connected to the tube engaging structure for effecting a resiliently biased movement of the tube engaging structure from a tube receiving position into a cutting cycle completion position, wherein the tube engaging structure is substantially adjacent and parallel to the saw blade. A handle is provided for manually rotating the tube engaging structure.

Improvement is desired.

### SUMMARY

There is disclosed a system for cutting an object, which facilitates remote cutting. As referred to herein, “remote cutting” may refer to cutting of an object by a user without direct manipulation of the object by the user, e.g. cutting an inaccessible tree branch using a pole-mounted (or boom-mounted) chainsaw.

In one aspect, the system comprises a cutting device defining a cutting edge; and an arm coupled to the cutting device to receive the object between the cutting edge and the arm, the arm configured to resiliently move away from the cutting edge as the object is drawn between the cutting edge and the arm to urge the object against the cutting edge to facilitate cutting of the object and to mitigate overloading of the cutting device.

In some embodiments, the arm is pivotably coupled to the cutting device about a pivot to receive the object between the cutting edge and the arm, the arm configured to resiliently pivot away from the cutting edge as the object is drawn towards the pivot to urge the object against the cutting edge to facilitate cutting of the object and to mitigate overloading of the cutting device.

Advantageously, such a configuration may enable application of an appropriate amount of force on to the object in a cutting plane. For example, the arm may push the object onto the cutting edge in response to light and inefficient cutting of the object by the cutting device. On the other hand, if the object is drawn onto the arm too aggressively, the arms are pushed outwards to prevent overloading of the motor.

During normal operation of a chainsaw, an object will feed itself into a cut upon application of relatively little pressure due to the associated feed pressure then generated by the chainsaw. It is desired to prevent excessive feed pressure since this tends to overload the motor. Advantageously, the resilient arms may be configured to swing or retract away from the blade under excessive feed pressure conditions to thereby reduce the applied force and hence relieve the motor by reducing the feed pressure. For example, springs and/or other components facilitating resilient operation of the arms may be configured based on a predetermined pressure, e.g. a threshold feed pressure or pressure with which the object is pushed on to the cutting edge. In some embodiments, a spring may be selected so that its spring constant leads to the arms retracting under a motor overload condition. For example, the spring may be sufficiently stiff to provide a force for generating feed pressure but sufficiently pliable to allow retraction upon generation of excessive feed pressure. Advantageously, motor overloading may be mitigated.

A boom may be coupled to the rotary cutting device, as mentioned previously. In some embodiments, no boom may be provided, or a boom provided may be coupled to one or more additional components facilitating remote cutting.

The pivot may be positioned on a guide of the cutting edge of the cutting device. The cutting device may be a chainsaw, a cutting chain being mounted on a peripheral edge of the guide.

A spring may provide resilient coupling, e.g. a circular spring (torsion spring) oriented along the pivoting axis. The spring may be coupled to the guide or other fixed structure and the arm at the pivot.

The spring may be a linear spring coupled to the arm at a first distance away from the pivot to exert a torque against the object to urge the object against the cutting blade to facilitate cutting of the object. A coupling bar may be pivoted about the pivot. First and second ends may be opposite ends of the coupling bar. The arm may be coupled to the first end. A linear restoring force may be provided via the second end to exert a torque.

The arm may extend symmetrically about the cutting blade. The arm is a first arm, a second arm is positioned opposite the first arm relative to the cutting edge and/or the guide. Each arm may be independently operable. The first and second arms may be splayed away from each other from the pivot. The first and second arms may extend parallel to each other on opposite sides of the cutting edge and/or the guide.

The guide may comprise a plurality of apertures to allow selective coupling of the arm to the guide.

The arm may define a tapered end to receive the object.

The arm may be spaced apart along the pivoting axis from a cutting edge.

The arm may be attached via clamp to the guide and/or the cutting device. The clamp may be a two-part clamp. The two-part clamp may comprise interlocking pieces that are joined together with the guide sandwiched in-between. The interlocking pieces may pass through apertures in the guide. The interlocking pieces may comprise hooked, e.g. L-shaped, protrusions and/or depressions for engagement with one another. The pieces may join together to form a sleeve surrounding the guide to clamp onto an exterior of the guide. The pieces may form a C-shaped clamp over the guide. Each piece may be substantially U-shaped to form a rectangular annular sleeve when coupled to each other.

The cutting device may be a chainsaw. The cutting device may be a brush cutter, or other rotary cutting tool or device. The arm may extend across the blade to provide two-sided support of the object being cut. A fence may be provided. The arm and the fence may be coupled to each other directly or via a center plate. The arm and the fence may each be independently rotatable about the center plate. The arm may be coupled to a body of the rotary cutting tool or device (brush cutter, grinder, chainsaw, or the like), e.g. a guide in the form of a disc guard, via torsion spring, such as a coil spring. The arm may be planar and/or arcuate.

Resilient rotation of the arm may be provided by a motor and/or sensor that are controlled by a controller. As described later, in some embodiments, the resilient rotation may be based on motor power draw.

There is disclosed a system for cutting an object. The system comprises a cutting device defining a motor and a cutting blade operably coupled to the motor; an arm pivotably coupled to the cutting device about a pivot to receive the object between the cutting blade and the arm, the arm configured to pivot away from the cutting blade as the object is drawn towards the pivot; a sensor to sense data indicative of motor power; and an actuator to rotate the arm in response to measurements of the sensor to control urging of the object against the cutting blade to facilitate cutting of the object.

There is disclosed a method of cutting an object using a cutting device powered by a motor. The method comprises generating data, during cutting, indicative of motor power; and controlling an arm opposite to the object based on the data to control a cutting force on the object.

There is disclosed a system for cutting an object using a cutting device powered by a motor. The system comprises a processor; computer-readable memory coupled to the processor and storing processor-executable instructions that, when executed, configure the processor to: generate data, during cutting, indicative of motor power; and control an arm opposite to the object based on the data to control a cutting force on the object.

There is disclosed a non-transitory computer-readable medium having stored thereon machine interpretable instructions which, when executed by a processor, cause the processor to perform a computer-implemented method of cutting an object using a cutting device powered by a motor, the method comprising: generating data, during cutting, indicative of motor power; and controlling an arm opposite to the object based on the data to control a cutting force on the object.

In various embodiments, the arm may be controlled based on sensor data to increase or decrease force on the object being cut. In various embodiments, the arm may be controlled to operate the motor efficiency, avoid motor overload, prolong motor life, and/or prolong battery run-time.

In some aspects, there is disclosed a system for cutting an object. The system also includes a cutting device defining a cutting edge; and an arm coupled to the cutting device to be resiliently rotatable away from the cutting edge and biased in an open position, the arm being angled away from the cutting edge in the open position to define, between the cutting edge and the arm, an expandable opening that is suitable to receive the object and to expand by pushing of the object on to the arm to rotate the arm away from the cutting edge as the object is drawn into the opening to urge the object against the cutting edge.

Implementations may include one or more of the following features. The system where the arm is coupled to the cutting device via a spring that is in a relaxed state in the open position to keep the arm spaced away from the cutting edge in the open position. The arm rotates away from the cutting edge about a pivot such that drawing the object into the opening by drawing the object towards the pivot expands the opening. The system may include a clamp that is clamped to a guide of the cutting edge and an end pivotably coupled to the arm. The system may include an extension spring coupled to the arm and a guide of the cutting edge such that rotation of the arm causes bending of the extension spring to generate a restoring force to return the arm to the open position. The extension spring is slidably received into a collar such that rotation of the arm causes an end of the extension spring to abut the collar to bend the extension spring. The arm is angled at least 45° away from the cutting edge in the open position. A portion of the arm defining an end of the opening is centered on a cutting plane defined by the cutting edge. The system further may include a boom coupled to the cutting device. The cutting device includes a motor configured to cause cutting of the object via the cutting edge, the system may include: a sensor to sense data indicative of motor power of the motor; an actuator coupled to the arm to rotate the arm towards and away from the cutting edge; and a controller configured to receive the data from the sensor and operably coupled to the actuator, the controller configured to control rotation of the arm in response to the data to control urging of the object against the cutting edge. The controller includes a processor; and computer-readable memory coupled to the processor and storing processor-executable instructions that, when executed, configure the processor to: receive the data during cutting; and control the arm opposite to the object based on the data to mitigate motor loading. The cutting device is a chainsaw, a cutting chain being mounted on a peripheral edge of a guide of the cutting edge. The arm includes: a first portion pivotably coupled to the cutting device and positioned proximal to the cutting edge; and a second portion pivotably coupled to the first portion and positioned distal from the cutting edge, the second portion coupled to the cutting device via the first portion. The second portion is configured for one-way rotation about the first portion to allow rotation of the second portion, about the first portion, towards the cutting edge and to hinder rotation of the second portion, about the first portion, away from the cutting edge. The arm includes a roller disposed at a terminal end of the arm. The arm includes a first tubular portion disposed in a second tubular portion, the arm is suitable to lengthened by telescoping of first and second tubular portions relative to each other. The arm is releasably attached to the cutting device. The arm is coupled to the cutting device via an actuator configured to cause resilient rotation of the arm towards and away from the cutting edge. The arm includes a wheel disposed at a terminal end of the arm distal from the cutting device to allow rolling of the wheel against the object as the object is received into the opening. The arm is a first arm, the system may include a second arm coupled to the cutting device to be resiliently rotatable away from the cutting edge and spaced apart from the first arm to sandwich the cutting edge in-between the first arm and the second arm, the first and second arms suitable to urge the object against the cutting edge as the object is drawn into the opening. The arm includes a wheel disposed at a terminal end of the arm distal from the cutting device to allow rolling of the wheel against the object when the object is received into the opening. The arm is a first arm, the apparatus may include a second arm configured to be coupled to the cutting device to be resiliently rotatable rotation away from the cutting edge and, when coupled to the cutting device, configured to be spaced apart from the first arm to sandwich the cutting edge in-between the first arm and the second arm, the first and second arms suitable to urge the object against the cutting edge as the object is drawn into the opening.

In some aspects, there is disclosed an apparatus for cutting an object using a cutting device defining a cutting edge. The apparatus also includes an arm; and a coupler coupled to the arm and suitable to be mounted to the cutting device to allow resilient rotation of the arm away from the cutting edge and to bias the arm in an open position, the coupler configured to angle the arm away from the cutting edge in the open position to define, between the cutting edge and the arm, an expandable opening that is suitable to receive the object and to expand by pushing of the object on to the arm to rotate the arm away from the cutting edge as the object is drawn into the opening to urge the object against the cutting edge.

Implementations may include one or more of the following features. The apparatus where the arm is configured to be coupled to the cutting device via a spring that is configured to be in a relaxed state in the open position to keep the arm spaced away from the cutting edge in the open position. The arm, when coupled to the cutting device, is configured to rotate away from the cutting edge about a pivot such that drawing the object into the opening by drawing the object towards the pivot expands the opening. The apparatus may include: a clamp configured to be clamped to a guide of the cutting edge and an end pivotably coupled to the arm. The apparatus may include an extension spring coupled to the arm and configured to be coupled to a guide of the cutting edge such that rotation of the arm, when coupled to the cutting device, causes bending of the extension spring to generate a restoring force to return the arm to the open position. The arm, when coupled to the cutting device, is configured to be angled at least 45° away from the cutting edge in the open position. The arm, when coupled to the cutting device, is configured such that a portion of the arm defining an end of the opening is centered on a cutting plane defined by the cutting edge. The cutting device includes a motor configured to cause cutting of the object via the cutting edge, the apparatus may include: an actuator configured to be coupled to the arm to rotate the arm, when coupled to the cutting device, towards and away from the cutting edge; and a controller configurable to receive data from a sensor and suitable to be operably coupled to the actuator, the sensor configured to sense data indicative of motor power of the motor, the controller configured to control rotation of the arm, when coupled to the cutting device, in response to the data to control urging of the object against the cutting edge. The cutting device is a chainsaw, a cutting chain being mounted on a peripheral edge of a guide of the cutting edge. The arm includes: a first portion configured to be pivotably coupled to the cutting device proximal to the cutting edge; and a second portion pivotably coupled to the first portion to be positioned distal from the cutting edge when the first portion is coupled to the cutting device, the second portion suitable to be coupled to the cutting device via the first portion. The arm includes a roller disposed at a terminal end of the arm. The arm includes a first tubular portion disposed in a second tubular portion, the arm is suitable to lengthened by telescoping of first and second tubular portions relative to each other. The arm is configured to be releasably attached to the cutting device. The apparatus may include: an actuator configured to couple the cutting device to the arm to cause resilient rotation of the arm towards and away from the cutting edge.

In some aspects, there is disclosed a kit for cutting an object using a cutting device defining a cutting edge. The kit also includes an arm; and a coupler to couple the arm to the cutting device to allow resilient rotation of the arm away from the cutting edge and to bias the arm in an open position when the arm is coupled to the cutting device via the coupler, the coupler configured to angle the arm away from the cutting edge in the open position to define, between the cutting edge and the arm, an expandable opening that is suitable to receive the object and to expand by pushing of the object on to the arm to rotate the arm away from the cutting edge as the object is drawn into the opening to urge the object against the cutting edge.

Implementations may include one or more of the following features. The kit where the arm is configured to be coupled to the cutting device via a spring that is configured to be in a relaxed state in the open position to keep the arm spaced away from the cutting edge in the open position. The arm, when coupled to the cutting device, is configured to rotate away from the cutting edge about a pivot such that drawing the object into the opening by drawing the object towards the pivot expands the opening. The kit may include a clamp configured to be clamped to a guide of the cutting edge and an end pivotably coupled to the arm. The kit may include an extension spring configured to be coupled to the arm and a guide of the cutting edge such that rotation of the arm, when coupled to the cutting device, causes bending of the extension spring to generate a restoring force to return the arm to the open position. The arm, when coupled to the cutting device, is configured to be angled at least 45° away from the cutting edge in the open position. The arm, when coupled to the cutting device, is configured such that a portion of the arm defining an end of the opening is centered on a cutting plane defined by the cutting edge. The cutting device includes a motor configured to cause cutting of the object via the cutting edge, the kit may include: an actuator configured to be coupled to the arm to rotate the arm, when coupled to the cutting device, towards and away from the cutting edge; and a controller configurable to receive data from a sensor and suitable to be operably coupled to the actuator, the sensor configured to sense data indicative of motor power of the motor, the controller configured to control rotation of the arm, when coupled to the cutting device, in response to the data to control urging of the object against the cutting edge. The cutting device is a chainsaw, a cutting chain being mounted on a peripheral edge of a guide of the cutting edge. The arm includes: a first portion configured to be pivotably coupled to the cutting device proximal to the cutting edge; and a second portion suitable to be pivotably coupled to the first portion so to be positioned distal from the cutting edge when the first portion is coupled to the cutting device, the second portion suitable to be coupled to the cutting device via the first portion. The arm includes a roller disposed at a terminal end of the arm. The arm includes a first tubular portion disposed in a second tubular portion, the arm is suitable to lengthened by telescoping of first and second tubular portions relative to each other. The arm is configured to be releasably attached to the cutting device. The kit may include: an actuator configured to couple the cutting device to the arm to cause resilient rotation of the arm towards and away from the cutting edge. The arm includes a wheel disposed at a terminal end of the arm distal from the cutting device to allow rolling of the wheel against the object when the object is received into the opening. The arm is a first arm, the kit may include a second arm configured to be coupled to the cutting device and the first arm to be resiliently rotatable away from the cutting edge and, when coupled to the cutting device, configured to be spaced apart from the first arm to sandwich the cutting edge in-between the first arm and the second arm, the first and second arms suitable to urge the object against the cutting edge as the object is drawn into the opening.

In some aspects, there is disclosed an apparatus for cutting an object using a cutting device defining a cutting edge. The apparatus also includes an arm; and a means for mounting the arm to the cutting device to allow resilient rotation of the arm away from the cutting edge and to bias the arm in an open position, where the arm is angled away from the cutting edge in the open position to define, between the cutting edge and the arm, an expandable opening that is suitable to receive the object, and the arm rotates away from the cutting edge as the object is drawn into the opening to expand the opening and to urge the object against the cutting edge.

Implementations may include one or more of the following features. The apparatus where the means includes a spring that is configured to be in a relaxed state in the open position to keep the arm spaced away from the cutting edge in the open position. The arm, when mounted to the cutting device, is configured to rotate away from the cutting edge about a pivot such that drawing the object into the opening by drawing the object towards the pivot expands the opening. The means includes a clamp configured to be clamped to a guide of the cutting edge and an end pivotably coupled to the arm. The means includes an extension spring coupled to the arm and configured to be coupled to a guide of the cutting edge such that rotation of the arm, when coupled to the cutting device, causes bending of the extension spring to generate a restoring force to return the arm to the open position. The means includes an extension spring coupled to the arm and configured to be coupled to a guide of the cutting edge such that rotation of the arm causes bending of the extension spring to generate a restoring force to return the arm to the open position, where the extension spring is received into the collar for free slidable rotation within the collar. The arm, when mounted to the cutting device, is configured to be angled at least 45 away from the cutting edge in the open position. The arm, when mounted to the cutting device, is configured such that a portion of the arm defining an end of the opening is centered on a cutting plane defined by the cutting edge. The cutting device includes a motor configured to cause cutting of the object via the cutting edge, the apparatus may include: an actuator configured to be coupled to the arm to rotate the arm, when coupled to the cutting device, towards and away from the cutting edge; and a controller configurable to receive data from a sensor and suitable to be operably coupled to the actuator, the sensor configured to sense data indicative of motor power of the motor, the controller configured to control rotation of the arm, when coupled to the cutting device, in response to the data to control urging of the object against the cutting edge. The cutting device is a chainsaw, a cutting chain being mounted on a peripheral edge of a guide of the cutting edge. The cutting device is a brush cutter. The arm includes: a first portion configured to be pivotably coupled to the cutting device proximal to the cutting edge; and a second portion pivotably coupled to the first portion to be positioned distal from the cutting edge when the first portion is coupled to the cutting device, the second portion suitable to be coupled to the cutting device via the first portion. The arm includes a roller disposed at a terminal end of the arm. The arm includes a first tubular portion disposed in a second tubular portion, the arm is suitable to lengthened by telescoping of first and second tubular portions relative to each other. The means allows releasable attachment of the arm to the cutting device. The means includes an actuator configured to couple the cutting device to the arm to cause resilient rotation of the arm towards and away from the cutting edge. The arm includes a wheel disposed at a terminal end of the arm distal from the cutting device to allow rolling of the wheel against the object when the object is received into the opening. The arm is a first arm, and the means is a first means, the apparatus may include a second arm configured to be coupled to the cutting device via a second means to be resiliently rotatable away from the cutting edge and, when mounted to the cutting device, configured to be spaced apart from the first arm to sandwich the cutting edge in-between the first arm and the second arm, the first and second arms suitable to urge the object against the cutting edge as the object is drawn into the opening.

In some aspects, there is disclosed a cutting system. The cutting system includes a cutting device and an apparatus, according to aspects described above.

In some aspects, there is disclosed a kit. The kit is suitable for forming systems, cutting system, and apparatuses, according to aspects described above.

Embodiments can include combinations of two or more of the above features.

Further details of these and other aspects of the subject matter of this application will be apparent from the detailed description included below and the drawings.

### DESCRIPTION OF THE DRAWINGS

Reference is now made to the accompanying drawings, in which:

FIG. 1A is a perspective view of two arms coupled to a guide of a cutting device for cutting an object, in accordance with an embodiment;

FIG. 1B is a top plan view of the guide of FIG. 1A illustrated together with the cutting device, in accordance with an embodiment;

FIG. 2A is a perspective view of a system for cutting an object, in accordance with an embodiment;

FIG. 2B is a top plan view of the system of FIG. 2A, in accordance with an embodiment;

FIG. 3A is a perspective view of a system for cutting an object, in accordance with an embodiment;

FIG. 3B is a top plan view of the system of FIG. 3A, in accordance with an embodiment;

FIG. 4A is a perspective view of a system for cutting an object, in accordance with an embodiment;

FIG. 4B is a side elevation view of the system of FIG. 4A, in accordance with an embodiment;

FIG. 5A is a perspective view of a system for cutting an object, in accordance with an embodiment;

FIG. 5B is a side elevation view of the system of FIG. 5A, in accordance with an embodiment;

FIG. 6A is an exploded view of an apparatus coupled to a guide of a cutting device, in accordance with an embodiment;

FIG. 6B is a side elevation view of the apparatus of FIG. 6A coupled to the guide, in accordance with an embodiment;

FIG. 6C is a cross-sectional view along the section 6C-6C in FIG. 6B, in accordance with an embodiment;

FIG. 7A is a perspective view of a system for cutting an object, in accordance with an embodiment;

FIG. 7B is a side elevation view of the system of FIG. 7A, in accordance with an embodiment;

FIG. 7C is a front elevation view of the system of FIG. 7A, in accordance with an embodiment;

FIG. 7D is an exploded view of the system of FIG. 7A, in accordance with an embodiment;

FIG. 7E is a side elevation view of the cutting blade of FIG. 7A, in accordance with an embodiment;

FIG. 7F is a cross-sectional view along the section 7F-7F in FIG. 7E, in accordance with an embodiment;

FIG. 7G is a side elevation view of a portion of the system of FIG. 7A, in accordance with an embodiment;

FIG. 7H is a cross-sectional view along the section 7H-7H in FIG. 7G, in accordance with an embodiment;

FIG. 7I is a cross-sectional view along the section 7I-7I in FIG. 7G, in accordance with an embodiment;

FIG. 7J is a cross-sectional view along the section 7J-7J in FIG. 7G, in accordance with an embodiment;

FIG. 7K is a cross-sectional view along the section 7K-7K in FIG. 7G, in accordance with an embodiment;

FIG. 7L is an enlarged view of the region 7L-7L in FIG. 7D, in accordance with an embodiment;

FIG. 7M is a top plan view of a cam, in accordance with an embodiment;

FIG. 7N is a side elevation view of the cam, in accordance with an embodiment;

FIG. 7O is a perspective of a piece of a two-piece clamp an, in accordance with an embodiment;

FIG. 7O is a perspective of a piece of a two-piece clamp, in accordance with an embodiment;

FIG. 7O is a perspective of a piece of a two-piece clamp, in accordance with an embodiment;

FIG. 7P is another perspective view of the piece of the two-piece clamp, in accordance with an embodiment;

FIG. 7Q is a side elevation view of the piece of the two-piece clamp, in accordance with an embodiment;

FIG. 8A is an exploded view of an apparatus of a system for cutting an object, in accordance with an embodiment;

FIG. 8B is a side elevation view of the apparatus of FIG. 8A, in accordance with an embodiment;

FIG. 8C is a cross-sectional view along the section 8C-8C in FIG. 8B, in accordance with an embodiment;

FIG. 8D is a perspective partial sectional view of the apparatus of FIG. 8A showing a spring thereof in a relaxed position with cams fully interlocked, in accordance with an embodiment;

FIG. 8E is a perspective partial sectional view of the apparatus of FIG. 8A showing a spring thereof in a compressed position with cams ramping against each other to cause an axial separation therebetween, in accordance with an embodiment;

FIG. 9A is a perspective view of a clamp of the system of FIG. 8A, in accordance with an embodiment;

FIG. 9B is a perspective view of the clamp of FIG. 9A, in accordance with an embodiment;

FIG. 9C is a perspective view of the clamp of FIG. 9C, in accordance with an embodiment;

FIG. 10A is a perspective view of a cam, in accordance with an embodiment;

FIG. 10B is a perspective view of a cam, in accordance with an embodiment;

FIG. 11 is a perspective view of an apparatus for cutting an object, in accordance with an embodiment;

FIG. 12A is a side elevation view of a system for cutting objects, in accordance with an embodiment;

FIG. 12B is a front elevation view of the system of FIG. 12A, in accordance with an embodiment;

FIG. 12C is an exploded view of the system of FIG. 12A, in accordance with an embodiment;

FIG. 12D is a top perspective view of the system of FIG. 12A, in accordance with an embodiment;

FIG. 12E is a bottom perspective view of the system of FIG. 12A, in accordance with an embodiment;

FIG. 13A is an exploded view of a system for cutting objects, in accordance with an embodiment;

FIG. 13B is a front elevation view of the system of FIG. 13A, in accordance with an embodiment;

FIG. 13C is a perspective view of the system of FIG. 13A, in accordance with an embodiment;

FIG. 14A is a front elevation view of a system for cutting objects, in accordance with an embodiment;

FIG. 14B is a top plan view of the system of FIG. 14A, in accordance with an embodiment;

FIG. 14C is a perspective view of the system of FIG. 14A, in accordance with an embodiment;

FIG. 15A is an exploded view of a system for cutting objects, in accordance with an embodiment;

FIG. 15B is a perspective view of the system of FIG. 15A, in accordance with an embodiment;

FIG. 15C is another perspective view of the system of FIG. 15A, in accordance with an embodiment;

FIG. 15D is a side elevation view of the system of FIG. 15A, in accordance with an embodiment;

FIG. 15E is another side elevation view of the system of FIG. 15A, in accordance with an embodiment;

FIG. 15F is a side elevation view of the system of FIG. 15A wherein a nylon guard replaces an extension for clearing debris, in accordance with an embodiment;

FIG. 15G is an enlarged view of the region 15G in FIG. 15F;

FIG. 16A is an exploded view of a system for cutting objects, in accordance with an embodiment;

FIG. 16B is a top plan view of the system of FIG. 16A, in accordance with an embodiment;

FIG. 16C is a perspective view of the system of FIG. 16A, in accordance with an embodiment;

FIG. 17A is a top plan view of a system for cutting objects, in accordance with an embodiment;

FIG. 17B is a perspective view of the system of FIG. 17A, in accordance with an embodiment;

FIG. 18 illustrates a block diagram of a computing device, in accordance with an embodiment of the present application;

FIG. 19A is a partially exploded front perspective view of a system for cutting objects, in accordance with an embodiment;

FIG. 19B is a front plan view of the system of FIG. 19A, in accordance with an embodiment;

FIG. 19C is a side elevation view of the system of FIG. 19A, in accordance with an embodiment;

FIG. 20 is a perspective view of a piece of a two-piece clamp used in the system of FIG. 19A, in accordance with an embodiment;

FIG. 21A is a partially exploded front perspective view of a system for cutting objects, in accordance with an embodiment;

FIG. 21B is a side elevation view of the system of FIG. 21A, in accordance with an embodiment;

FIG. 22A is a perspective view of an apparatus coupled to a guide, in accordance with an embodiment;

FIG. 22B is a top plan view of the apparatus of FIG. 22A, in accordance with an embodiment;

FIG. 23A is a side elevation view of a system with a two-portion arm in an open position, in accordance with an embodiment;

FIG. 23B is a side elevation view of the system of FIG. 23A with the two-portion arm in a wide-open position, in accordance with an embodiment;

FIG. 23C is a side elevation view of the system of FIG. 23A with the two-portion arm retracted into a closed position, in accordance with an embodiment;

FIG. 24 is a perspective view of an apparatus for cutting objects, in accordance with an embodiment;

FIG. 25 is a perspective view of an apparatus for cutting objects, in accordance with another embodiment;

FIG. 26A is a perspective view of an apparatus, in accordance with an embodiment;

FIG. 26B is an exploded perspective view of the apparatus of FIG. 26A, in accordance with an embodiment;

FIG. 27 is a perspective view of an apparatus, in accordance with yet another embodiment;

FIG. 28 is a perspective view of an apparatus, in accordance with a further embodiment;

FIG. 29A is a side elevation view of an apparatus moving into an open state, in accordance with yet another embodiment;

FIG. 29B is an enlarged perspective view of the apparatus in FIG. 29A;

FIG. 30A is a side elevation view of the apparatus of FIG. 29A moving into a closed state, in accordance with an embodiment;

FIG. 30B is an enlarged perspective view of the apparatus in FIG. 30A; and

FIG. 31 is a side elevation view of the apparatus in FIG. 30A from an opposite side of the guide, in accordance with an embodiment.

### DETAILED DESCRIPTION

Aspects of various embodiments are described in relation to the figures.

An apparatus is disclosed for coupling to a cutting device to form a system for cutting objects. Advantageously, the apparatus may be formed using a kit of parts that may be readily assembled.

In some embodiments, the apparatus comprises an arm that is mounted to a guide (or guide bar) of a chainsaw to be resiliently rotatable about a cutting edge of the guide. For example, at rest, the arm is in an open position by being angled away from the guide to define an opening for receiving an object to be cut. As the object is drawn into the opening, the arms may be rotated apart from each other and a force opposing such rotation may then be generated, which may then facilitate cutting of the object.

In some embodiments, the apparatus may be coupled to a cutting device via a preexisting guide of the cutting device. In some embodiments, the apparatus may be integrated with a guide or otherwise pre-fastened (including removably fastened) to a guide, and then coupled to the cutting device by mounting of such a guide to a cutting device.

The system is particularly advantageous for remotely cutting/pruning foliage, e.g. using a boom, as a user may have limited ability to apply forces and/or position the cutting device in such situations. Nevertheless, it is understood that the system may be used for cutting/pruning in other scenarios, e.g. those without the need for remote cutting. For example, aspects disclosed herein may facilitate cutting by a user directly holding on to a cutting device without the use of a boom or pole. Furthermore, aspects disclosed herein may be useful for cutting tree branches, pipes, conduits, and/or other similar objects.

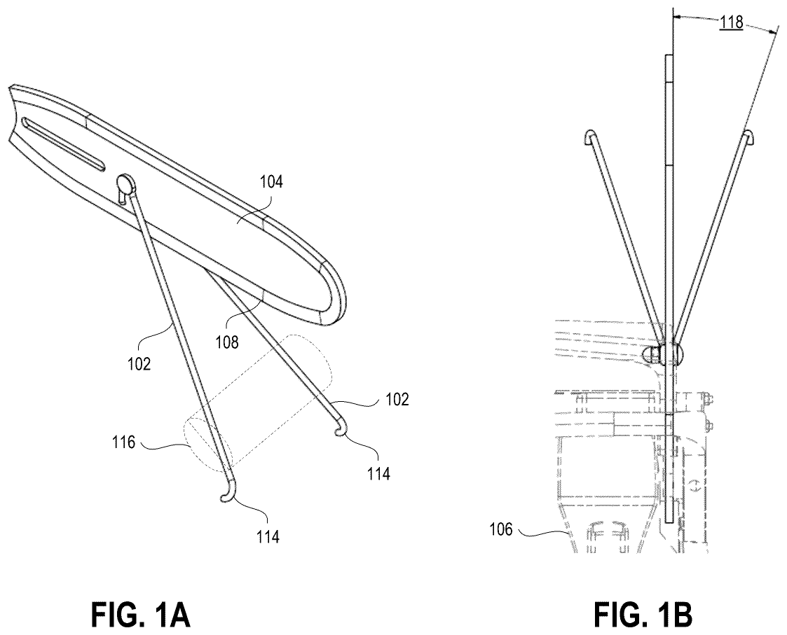

FIG. 1A is a perspective view of two arms 102 coupled to a guide 104 of a cutting device 106 for cutting an object 116, in accordance with an embodiment.

FIG. 1B is a top plan view of the guide 104 of FIG. 1A illustrated together with the cutting device 106, in accordance with an embodiment.

In FIGS. 1A-1B and the following figures, the cutting device 106 is shown using construction lines (dashed construction lines).

The guide 104 is a guide bar of a chainsaw (an example of a rotary cutting device). The guide 104 may have mounted thereon a chain that rotates around a cutting edge 108 of the guide 104 in order to generate a sawing motion that saws (or cuts) through objects. In various embodiments, it is understood that the guide and/or cutting edge may not in itself provide a sharp edge or a grinding edge. For example, sharp edges may be provided by elements on a chain of the chainsaw to achieve sawing, which sharp edges may be non-parallel to the cutting edge. As referred to herein, the cutting edge refers to an edge of the cutting device that at least partially defines a cutting plane along which the object is cut by the cutting device. The guide may serve to guide the cutting edge along the cutting plane. For example, the guide may be a bar or plate that extends parallel to the edge and normal to a surface of the object that is being cut.

In the embodiments of FIGS. 1A-1B, the arms 102 are fixed to the guide 104 and may act as springs. In various embodiments, the arms 102 (or a projection thereof in a plane parallel to the guide 104) may define an open position at about 45° from the guide 104 in a plane parallel to the guide 104. In various embodiments, arms 102 may trap, guide, and/or steady objects for cutting within an opening defined between the guide 104 and the arms 102. In various embodiments, the open position may be associated with a resting, relaxed, or neutral state of the arms 102 (or resilient elements attached thereto) to keep the arms 102 spaced apart from the cutting edge in the open position by causing a tendency or bias to return to the open position once displaced therefrom.

To achieve cutting, the cutting device may rely on a force normal to the surface of the object. Such a force may be, or be generated by, a reaction force. In typical cutting devices, an operator would push the cutting edge against the object, which would produce an equal and opposite force pushing the cutting edge against the operator, the object being held in place to prevent its movement to allow the reaction force to be generated. When the object being cut is accessible, an operator would hold the object in place by placing a support underneath it or rely on pre-existing structures to hold the object in place, e.g. a large tree limb may be sufficiently strongly attached to prevent movement when pushed against for cutting, as described. However, when cutting inaccessible objects (including loose branches which are not solidly fixed to a tree or the ground), e.g. by means of a boom attached to the cutting device, pushing the cutting edge into the surface of the object as well as holding the object in place so as to generate a reaction force may both be difficult or impossible tasks. The arms may provide a force in such circumstances.

In some embodiments, the arms 102 may be tubular. In some embodiments, the arms 102 may be, or may be made of, spring wire. In some embodiments, the arms 102 themselves may be resilient and may allow a certain amount of deformation upon receiving the object. For example, in some embodiments, the arms 102 may generate a deformation stress so that the object 116 is pushed against the cutting edge 108 by a restoring force associated with deformation of the arms 102.

Advantageously, such a restoring force may be generated by translating the cutting edge towards the object at angles that are parallel to the surface of the object. Such a force may allow more efficient cutting and moderate motor loading. For example, it may not be necessary to directly push the cutting edge normal to (and into) the surface of the object since the resiliently deformable arms serve to provide resistance or reaction to translation towards the object, parallel to its surface, via resistance to rotation. Resistance or reaction is transmitted to the object as a reaction force pushing the object into the cutting edge (and perpendicular to the surface of the object). As such, efficient cutting of inaccessible objects may be achieved. For example, inaccessibly high tree branches and limbs may be cut by boom having mounted thereon a cutting device having arms as described, thereby reducing or circumventing costs, time, and hazards associated with a human worker scaling the tree to cut these inaccessibly high tree branches and limbs.

In some embodiments, the arms may be non-parallel. For example, the arms 102 may form an angle 118 between 0° and 90°, 10° and 80°, or about 45° with the guide 104, e.g. the angle may refer to an angle between projections of the arms 102 in a plane perpendicular to the guide 104 and/or the cutting edge 108, as shown in FIG. 1B. The arms may be positioned in such a non-parallel manner to avoid interference with the guide 104 and the cutting edge 108. Advantageously, in some embodiments, the need for spacers, or relatively large spacers, to maintain a clearance between the arms 102 and the guide 104 may be avoided. However, it is understood that in some embodiments, the arms 102 may be parallel and may be implemented with or without spacers.

In the various embodiments described herein, arms for supporting objects for cutting are substantially symmetric about the guide 104 and the cutting edge 108. However, it is understood that in certain circumstances, asymmetric arrangements and/or components may be used to achieve objectives.

It is noted that in various embodiments, a ramping effect may be achieved. The arms may act as a ramp, directing the object up and into the cutting edge, e.g. at approximately 45°. The cutting edge may draw the object towards the arms (ramp) providing the force to drive the object up the ramp and thus into the cutting edge.

In various embodiments, the arms may define ends 114 that are configured to facilitate sliding the object to slide on and/or off the arms. For example, the end may be curved, e.g. arcuately curved, away from the guide (and cutting edge) so as to effectively form a ramping surface for the object. In some embodiments, the end may be fully looped to avoid catching on brush or branches upon retraction of the cutting device. Such features may be particularly helpful during remote operation since precise positioning may be difficult in such circumstances.

Advantageously, each arm 102 may be substantially independently coupled to the guide 104. In some embodiments, a single arm 102 may be used since it may be advantageous to draw the cutting edge closer to the trunk of the tree. For example, this may allow effective reaction force to be generated and stabilization achieved when cutting irregular objects. For example, this may facilitate positioning of the guide 104 for cutting since the operator would need to engage both arms 102 to avoid an unbalanced force. The non-parallel orientation of the arms 102 may provide further advantages for positioning since a larger extent of the object may need to be engaged with the arms 102 to avoid an unbalanced reaction force on the object 116. In some embodiments, advantageously, the arms 102 may provide a reference for an operator to determine the location of the guide 104 and the cutting edge 108, e.g. midway between the two arms 102. Such referencing may be particularly useful during remote operation of the cutting device. For example, such referencing may be particularly helpful when the guide 104 and/or the cutting edge 108 may not be visible, may be occulated, and/or otherwise be obscured (such as due to objects, weather, and/or distance).

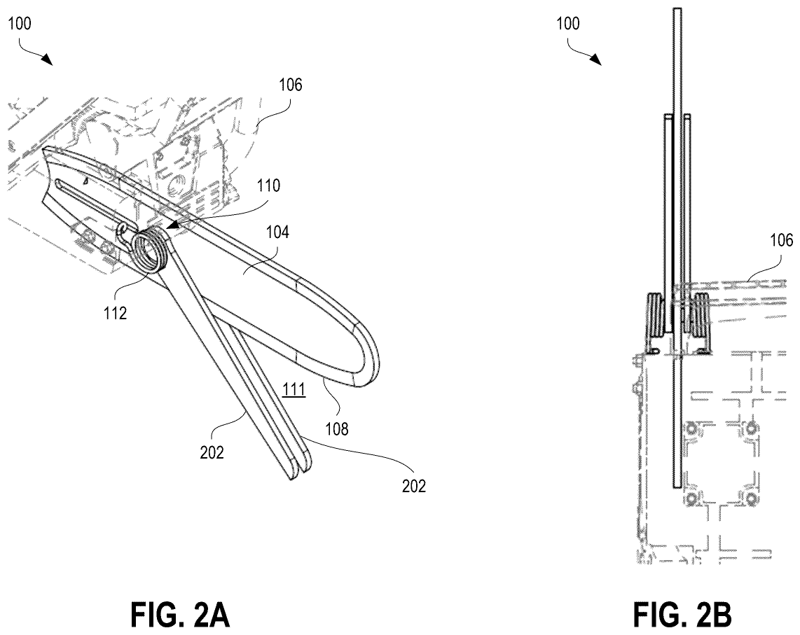

For further clarity, in the following, where deemed helpful to highlight different embodiments of an element, analogous parts may be labelled with reference numerals having distinct first digits but having in common their last two digits. For example, arms may be referred to as arms 102 and arms 202 in, respectively, in FIGS. 1A-1B and FIGS. 2A-2B.

FIG. 2A is a perspective view of a system 100 for cutting an object, in accordance with an embodiment.

FIG. 2B is a top plan view of the system 100 of FIG. 2A, in accordance with an embodiment.

Referring to FIGS. 2A-2B, the system includes a cutting device that is coupled to a guide, which is then coupled at pivot(s) 110 to twin arms 202 that extend below the guide and, in particular, below a cutting edge defined around the guide. The arms 202 (each separately, or both together) are pivotably coupled to the cutting device, e.g. to the guide or other component of the cutting device 106, about pivots 110 to receive the object between the cutting edge 108 (i.e. a portion of the perimeter guide track) and the arms 202. In particular, the arms 202 may be coupled to the cutting device for resilient rotation (and to be resiliently rotatable) to and away from the cutting edge.

The arms 202 in FIGS. 2A-2B are coupled to the cutting device in an open position, wherein the arms 202 are angled away from the cutting edge so as to define, between the cutting edge and the arms 202, an expandable opening 111 suitable to receive an object for cutting. The arms 202 may be biased in the open position so that rotation to or away from the cutting edge from the open position may cause the arms 202 to be urged back to the open position, e.g. by a spring force caused by a spring bias.

In some embodiments, only a singular arm may be coupled to a pivot 110. The arms 202 allow supporting the object during cutting. In various embodiments, pivots 110 may include a first pivot about which a first arm is coupled to the guide 104 and a second pivot about which a second arm is coupled to the guide 104, the first and second pivots defining a common axis of rotation and being axially spaced apart from each other with the guide 104 intervening in-between. The axis of rotation may be normal to the guide 104.

Pivots 110 may refer to a singular pivot 110 or a pivot 110 associated with each arm 202. Each arm 202 may be coupled to the guide via a corresponding revolute joint that allows rotation in along a single axis, e.g. an axis normal to the guide.

The arms 202 are parallel to each other and positioned adjacent to the guide so as to form a slot between the arms. The arms 202 allow supporting an object at multiple points thereof. However, it is understood the arms 202 may be non-parallel in some embodiments.

As mentioned previously, the arms 202 may be coupled to the cutting device via a spring 112 to generate a spring force when the arms are rotated away from the open position. The open position may be an equilibrium position, e.g. as may be defined by a spring being in a relaxed state, unstretched state, or otherwise configured to generate no net restoring force, such that the arm is kept spaced away from the cutting edge in the open position. In some embodiments, a plurality of springs may be configured to act as the spring 112. For example, each spring may be configured to generate a restoring force, while the plurality of springs may generate no net force.

In some embodiments, the spring 112 is a torsion spring positioned at the pivot and coupled to the guide and the arms. In various embodiments, the spring 112, the guide, and the arms may be positioned so as to rotate about a common axis. The spring 112 may be positioned so as to undergo torsion about such an axis. For example, in some embodiments, the torsion spring may be a coil spring. It is understood that, in some cases, other types of torsion springs may be deployed.

Each arm 202 may be coupled to the guide by means of a corresponding torsion spring. The torsion springs provide resistance against rotation of the arms about the pivot. A torsion spring may be attached to the guide at one end thereof and attached to the guide at another end thereof so as to define a resting (angular) position of the guide relative to the guide and the pivot.

Each arm may be sandwiched between the guide and a corresponding torsion spring. Advantageously this may allow access to the torsion spring by a user to make adjustments or make replacements.

In various embodiments, the arms 202 may be substantially rigid, e.g. the bars may be constructed of metal bars that are substantially rigid relative to the spring 112 to allow flexure of the spring 112 without any substantial flexure of the arms 202.

In various embodiments, the arms 202 (or a projection thereof in a plane parallel to the guide 104) may be configured to have a resting, relaxed, or neutral position at about 45° from the guide 104 about the pivot in a plane parallel to the guide 104. The arms may be configured to resiliently return to the resting position when rotating away therefrom. For example, pivoting the arms to an angle larger than an angle associated with the resting position (e.g. larger than) 45° may generate a restoring force to force the arms back towards the guide. In some embodiments, a restoring force may be generated when the arms are pivoted to an angle smaller than the angle associated with the resting position (e.g. smaller than) 45°.

The outer ends of the arm 202, in the neutral position, are generally sufficiently open to receive object(s) for cutting, e.g. branches or limbs of trees. In various embodiments, the arm 202 may be limited from pivoting more than 90° from the guide 104 and/or cutting edge. For example, one or more detent(s), spacer(s), or other components may be provided for such purposes. It is understood that as the pivot angle of the arm 102 approaches an angle of 90° away from the guide 104 and/or cutting edge, the arm 102 becomes increasing ineffective for regulating feed pressure, depth of cut, and/or motor loading.

In various embodiments, the arm 202 may be freely pivotable towards the guide 104. Advantageously, this may prevent interference between the arm 202 and branches or other such obstacles, i.e. the arm 202 may pivot towards the guide 104 to reduce the chance that the arm 202 engages with such obstacles. In some embodiments, mitigation of such fouling may be an important advantage.

As mentioned previously, the arms may provide a force that is needed when cutting inaccessible objects, e.g. by means of a boom. In particular, the arms may be configured to resiliently rotate away from the cutting edge to expand the opening as the object is drawn into the expandable opening and/or towards the pivot by pushing of the object on to the arms. Urging of the object against the cutting edge by a force normal to the surface of the object facilitates cutting of the object. Additionally, the arms are spring-loaded (or otherwise resiliently pivotable) such that if the object is drawn onto the arms too aggressively, i.e. the motor is overloaded or loaded too quickly, the arms open up (e.g. from 45° to closer to) 90° to reduce the motor loading. For example, motor stall due to overloading may be mitigated in this manner.

In reference to the ramping effect, the spring-loaded nature of the arms allows the arms to fold back from their original position in the open position (e.g. at) 45° to a more wide-open position, e.g. up to 90°. The further back the arms fold, the less ramp effect may occur and consequently less force is applied on the cutting edge. This reduces motor power.

As referred to herein, an overloaded motor may refer to a motor that is under excessive load such that the motor torque, or torque made available as a result of the motor's working, is insufficient, i.e. it is less than a torque needed to maintain rotation of the load against resistance. Overloaded motors may draw excessive current, overheat, and be prone to failure.

Advantageously, a suitable (reaction) force may be generated by translating the cutting edge towards the object at angles that are parallel to the surface of the object due to deformation of the spring. Such a force may allow more efficient cutting and moderate motor loading. For example, it may not be necessary to directly push the cutting edge normal to (and into) the surface of the object since the resiliently pivoting arms serve to provide resistance or reaction to translation towards the object, parallel to its surface, via resistance to rotation. Resistance or reaction is transmitted to the object as a reaction force pushing the object into the cutting edge (and perpendicular to the surface of the object). As such, efficient cutting of inaccessible objects may be achieved. For example, inaccessibly high tree branches and limbs may be cut by boom having mounted thereon a cutting device having arms as described, thereby reducing or circumventing costs, time, and hazards associated with a human worker scaling the tree to cut these inaccessibly high tree branches and limbs.

Advantageously, the arms 202 (or arms 102) may be used to support the cutting tool on the ground, e.g. as a stand. The springs of the arms 202 (or the arms themselves, as in the embodiments of FIGS. 1A-1B) may be adapted for such purposes, e.g. may sufficiently rigid.

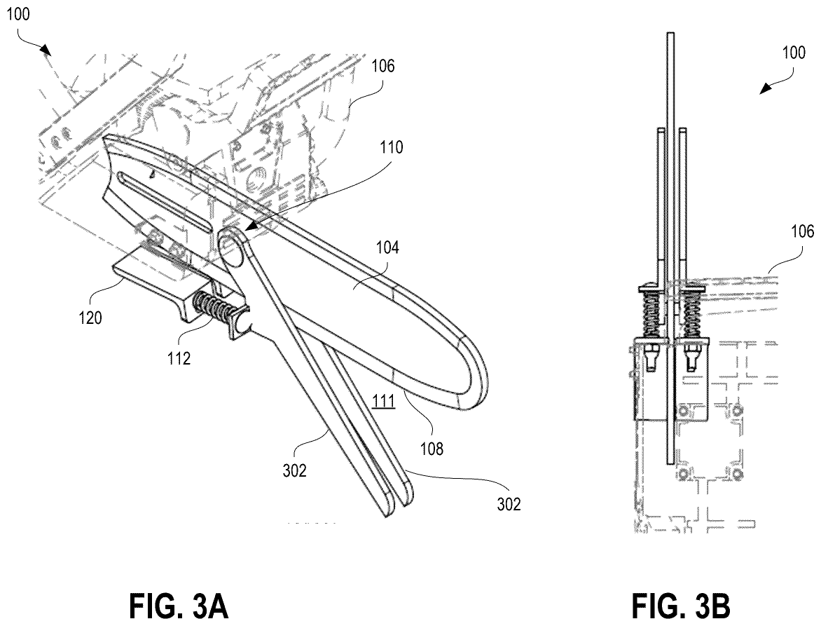

Various embodiments are now described in reference to FIG. 3A and drawings that follow thereafter. The principle of operation of such embodiments may be similar in certain respects to that of the embodiment shown in FIG. 2A.

FIG. 3A is a perspective view of a system 100 for cutting an object, in accordance with an embodiment.

FIG. 3B is a top plan view of the system 100 of FIG. 3A, in accordance with an embodiment.

The system in FIGS. 3A-3B comprises a cutting device coupled to arms 302 that all resilient rotation about pivot 110. The arms are coupled directly to guide 104 to pivot thereabout. For example, the arms 302 may be coupled to a midpoint of the guide 104 between opposite edges thereof. Opposite edges may refer to cutting edge 108 and an edge opposed thereto. The arms 302 may be coupled to the guide 104 by a rotating joint or a revolute joint at the pivot 110.

Resistance to rotation about the pivot 110 away from the guide 104 may be achieved by springs 112 coupling the cutting device to the arms 302. The springs 112 may each be a linear spring. In various embodiments, the springs 112 may be advantageously horizontally oriented in alignment with the cutting edge 108, as shown in FIGS. 3A-3B. For example, in some embodiments, the springs 112 may be coil springs with a helical or coil axis aligned with the cutting edge 108 or with a substantially portion of the cutting edge 108. It is understood that, in some cases, other types of linear springs may be deployed.

The springs 112 may couple the arms 302 to a portion of the cutting device and not directly to the guide 104. Advantageously, this may lead to greater rigidity of the guide 104 when the spring 112 is acted upon as the arms 302 are forced open during cutting, thereby allowing more accurate cuts. In some embodiments, the spring 112 may be coupled a coupler 120 abutting and/or attached to the cutting device. The coupler 120 may be an extension, platform, flange, or other type of rigid structure. In some embodiments, the coupler 120 may be removably coupled to the cutting device to allow removal and replacement.

It is understood that, in some embodiments, the spring 112 may couple the arms 302 directly to the guide 104.

The arms 302 may be elongated and extend a longitudinal length away from the pivot 110, normal to the axis of rotation about the pivot 110. In some embodiments, the arms 302 may be coupled to the spring 112 at a portion of the arms 302 positioned a distance from the pivot 110, normal to the axis of rotation of the pivot 110, that is less than half or one-third the longitudinal length described above and that is greater than one-sixth the longitudinal length. In various embodiments, such a longitudinal length may facilitate generation of sufficient moment or torque on the object during cutting, while avoiding interference with the pivot 110 and the joints defining the pivoting connection between the arms 302 and the guide 104. In various embodiments, the distance from the pivot 110 may be based on the spring constant and a desired force at distal end of the arms 302.

Each arm 302 may be coupled to its corresponding spring 112 via a flange extending outwardly from the arm 302.

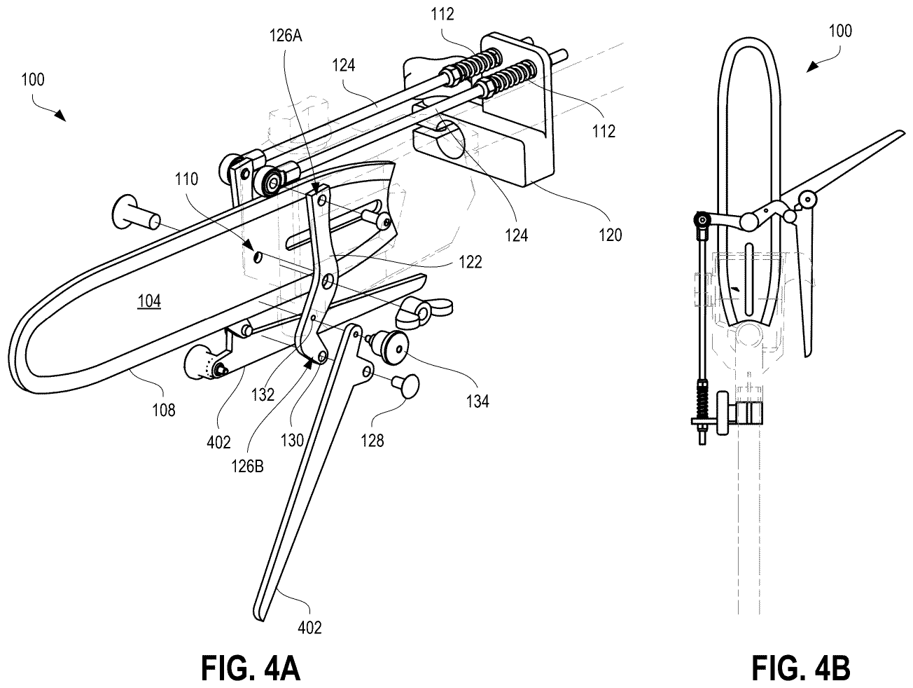

FIG. 4A is a perspective view of a system 100 for cutting an object, in accordance with an embodiment.

FIG. 4B is a side elevation view of the system 100 of FIG. 4A, in accordance with an embodiment.

In FIGS. 4A-4B, the cutting device is shown with a boom attached thereto, e.g. to hoist the cutting device to cut objects that are too high for an operator to access or to allow cutting of objects at a stand-off distance. For example, a tree branch in an interior of the foliage of a tree may be cut by boom held by a user that is clear of any of the foliage, e.g. at a stand-off distance defined by the length of the boom.

The system has arms 402 for applying a reaction force on to objects that are being cut, as described previously. The arms 402 may be fixedly or rigidly coupled to corresponding coupling bars 122. The coupling bars 122 may be pivotably coupled to guide 104 of the system, e.g. at a midpoint of the guide 104 between cutting edge 108 and an edge opposite thereof. The coupling bars 122 may further be coupled to spring-loaded members 124 that are coupled to the cutting device. In various embodiments, a coupler 120 may be used to couple the spring-loaded members 124 to the cutting device.

The coupling bars 122 may be coupled to the members 124 and the arms 402 at opposite ends 126A, 126B of the coupling bars 122, or opposite portions thereof relative to the location the coupling bars 122 couples to the guide 104. As such, a force applied to the coupling bars 122 via the members 124 is transmitted as a moment to the arms 402 via the coupling bars 122. Advantageously, a torque multiplier effect (mechanical advantage) is achieved. For example, a torque couple may thereby be achieved via a reaction force on an object being cut.

At the end 126B, the coupling bars 122 may be attached or coupled to the coupling bar 122 via corresponding fasteners 128 situated at first positions of the respective coupling bars 122 through apertures 130 of the respective coupling bars 122. In some embodiments, the fasteners 128 may form revolute joints allowing free planar rotation of the arms 402 in planes normal to the axis of rotation. The axis of rotation may be a common axis passing through corresponding apertures 130 of the two coupling bars 122 on opposite sides of the guide 104.

At the end 126B, the coupling bars 122 may further be attached or coupled to the coupling bar 122 via corresponding fasteners 134 situated at second positions of the respective coupling bars 122 through apertures 132 of the respective coupling bars 122. Coupling of each arm 402 to two positions on the corresponding coupling bar 122 may be advantageous as it may cause the arm 402 to be fixed or held in-place relative to the respective coupling bar 122 by means of two revolute joints for the coupling bar 122.

In various embodiments, the fasteners 134 may be removable or releasable so as to allow selective rotation of the arms 402 about the fastener 128. The fasteners 134 may be spring pin knobs with large grabbing knobs or surfaces for easy handling by a user. For example, this may allow retraction of one or more of the arms 402 to prevent engagement with the object; in FIG. 4A, the arm 402 shown without components exploded may be in a retracted position. This may allow selective engagement of the arms 402. This may allow the system to be used with the arms 402 in retracted position, where the arms 402 are not operational and may not hinder movement and positioning of the guide 104, until the arms 402 are to support cutting. The arms 402 may be held in the retracted position by friction in the corresponding joints formed by the fasteners 128. Such friction may be sufficient as the force applied on to the arms 402 in the retracted position may not be significant, e.g. the force may be primarily associated with the weight of the arms 402. On the other hand, the force on the arms 402 when the arms 402 are in an open configuration and engaged with the object may be significant due to reaction forces generated by the object. As such, in the open configuration, the arms 402 are supported by fasteners 128, 134 that hold the arms 402 fixed in-place relative to the coupling bars 122 when the arms 402 are engaged with the object.

It is understood that, in some embodiments, the fasteners 128 may fixedly attach the coupling bars 122 to the arms 402, e.g. by integral coupling. In such cases, the fasteners 134 may not be necessary to fix the arms 402 in place and so may not be provided or may be provided for additional rigidity and to further support the arms 402.

In some embodiments, the coupler 120 may abut the rear of the cutting device without being attached thereto and may be substantially held in place by friction. For example, the coupler 120 may be retained on to the cutting device by a spring force applied by the members 124 onto the coupler 120 that pushes the coupler 120 on to the rear of the cutting device. It is understood that, in some embodiments, the coupler 120 may be additionally or alternatively attached or clamped to the cutting device.

Springs 112 may define a resting position of the members 124. Translation of the members 124 away from the resting position may generate an opposing restoring force. The members 124 may be slidably engaged in openings in the coupler 120 and fixedly coupled to the coupling bar 122 such that the members 124 may be constrained to translate along a single direction. This direction may be aligned with the cutting edge 108. Resistance to the sliding motion may then be provided by the springs 112. The members 124 may be retained within corresponding springs 112. The springs 112 may abut the coupler 120 and may be prevented from sliding through the coupler 120. The springs 112 may be larger than the openings that have received therein the members 124. For example, the springs 112 may be coil springs with a diameter larger than the openings such that the coil springs (linear coil springs) rest on the coupler 120 and thereby need to be compressed to allow sliding of the members 124 into the openings and away from the guide 104.

While the foregoing discussion described both arms 402, it is understood that, in some embodiments, each of the arms 402 may be operated independently and selectively, e.g. as shown in the embodiments of FIGS. 4A-4B. In some embodiments, the arms 402 may be coupled for common operation, e.g. fasteners for engaging with a single coupling bar may be replaced with elongated fasteners configured to engage both coupling bars 122 at the same time (for example fasteners 128, 134 may be replaced with a pair of elongated fasteners extending across and underneath the guide 104 to couple the arms 402 to each other).

In various embodiments, the members 124 may be disengageable from the coupler 120 so as to allow components to be withdrawn to avoid fouling or may be sufficiently long to be withdrawn to mitigate fouling.

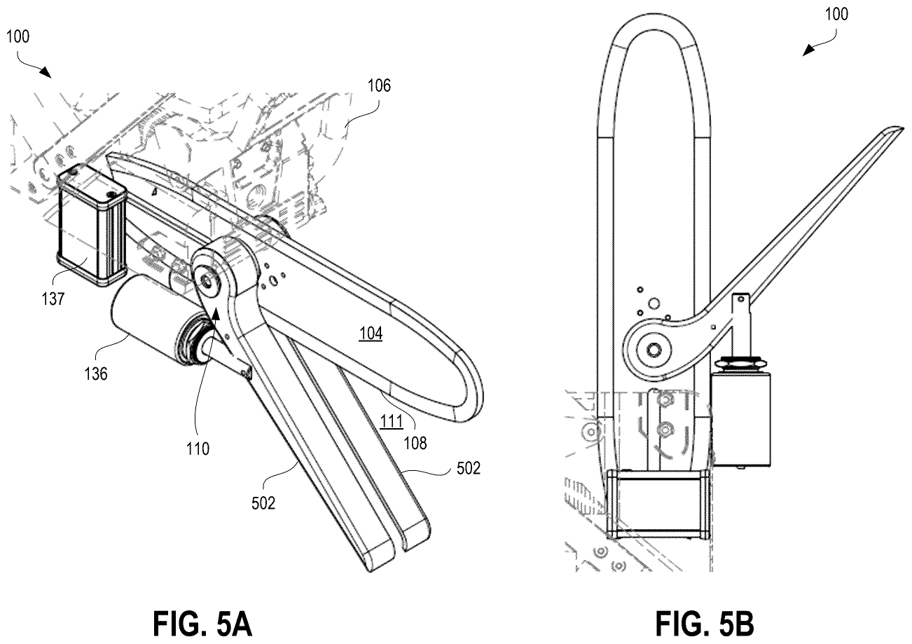

FIG. 5A is a perspective view of a system 100 for cutting an object, in accordance with an embodiment.

FIG. 5B is a side elevation view of the system 100 of FIG. 5A, in accordance with an embodiment.

Instead of using springs, the embodiment in FIGS. 5A-5B use (one or more) actuators 136 (such as motors) that may be electronically controlled using a controller 137 to drive the actuators 136 to move arms 502 and/or may provide data to the controller for operation thereof. The actuators 136 may be configured to cause resilient rotation of the arms 502 towards and away from the cutting edge. In various embodiments, linear actuators, electric motors, hydraulic motors, pneumatic motors, or other types of actuators may be used. The controller 137 may be coupled to a sensor, configured to sense data indicative or motor power or actuator power, to provide feedback control to cause (or prevent, and/or otherwise generally control) rotation of the arm in response to the data to control urging of the object against the cutting edge. For example, the sensor may be a sensor of a motor of a cutting device powered by the motor (e.g. a saw motor). In some embodiments, the sensor may be sensor for measuring electrical current drawn by the saw motor. For example, the sensor may allow control of motor(s) based on power drawn or the magnitude/characteristics of the electrical current received by the saw motor. For example, each actuator 136 may be coupled to a corresponding arm 502. In some embodiments, a single actuator 136 may be provided for both arms 502 with, or without, additional motors. In some embodiments, each actuator 136 may be independently operated. In some embodiments, the actuators 136 may be coupled for common operation.

The arm may be controlled (in feedback) based on data indicative of motor power, e.g. obtained by sensors, to control a cutting force on the object. In various embodiments, the cutting force may be determined or inferred based on motor power. As such, in various embodiments, motor power may be controlled. In various embodiments, the arm may be controlled based on such data to increase or decrease force on the object being cut. In various embodiments, the arm may be controlled to operate the motor efficiency, avoid motor overload, prolong motor life, and/or prolong battery run-time.

In some embodiments, when the motor approaches its peak loading during cutting, the arms 502 may be further be opened towards 90° to relieve the cutting pressure on the guide 104 (and cutting edge 108). This may moderate the power draw of a motor of the cutting tool.

In some embodiments, during operation, the data generated by the sensor may be indicative of or may be used to determine an indication of overloading of the saw motor. In response such overloading, or upon receiving an indication thereof, the actuators act to open the arms 502, i.e. actuatably move them away from the object by a greater angular distance or reduce a force applied thereto. For example, this may mimic an effect of spring-loaded arms, described earlier.

In some embodiments, the arms 502 may also be spring loaded. As the object is drawn on to the arms 502 sufficiently aggressively, motors of the cutting device may begin to stall due to overloading thereof. Upon stalling, initiation thereof, or during a pre-stall phase, the actuators 136 may be controllable to pivot the arms 502 away from the object, i.e. to pivotably open the arms 502. This may relieve cutting pressure on the guide 104 and/or prevent or mitigate stalling of the motors of the cutting device. In various embodiments, measurements or sensing of a physical phenomenon indicative of power drawn by motor(s) may be used to control the arms 502 by a controller. In some embodiments, the arms 502 may be spring loaded to relieve cutting pressure to mitigate stalling.

In various embodiments, such automatic control systems may be tuned to particular guides 104 and actuators 136 such that the saw motor is kept running at optimum or a most appropriate power to maximize cutting speed as well as battery life on each cut or to find a most appropriate cutting speed to achieve efficient cutting. For example, efficiency may be determined based on duration for cutting, energy consumption, and wear and tear. For example, a control objective may be to reduce or minimize a performance criterion or cost function that depends on such factors.

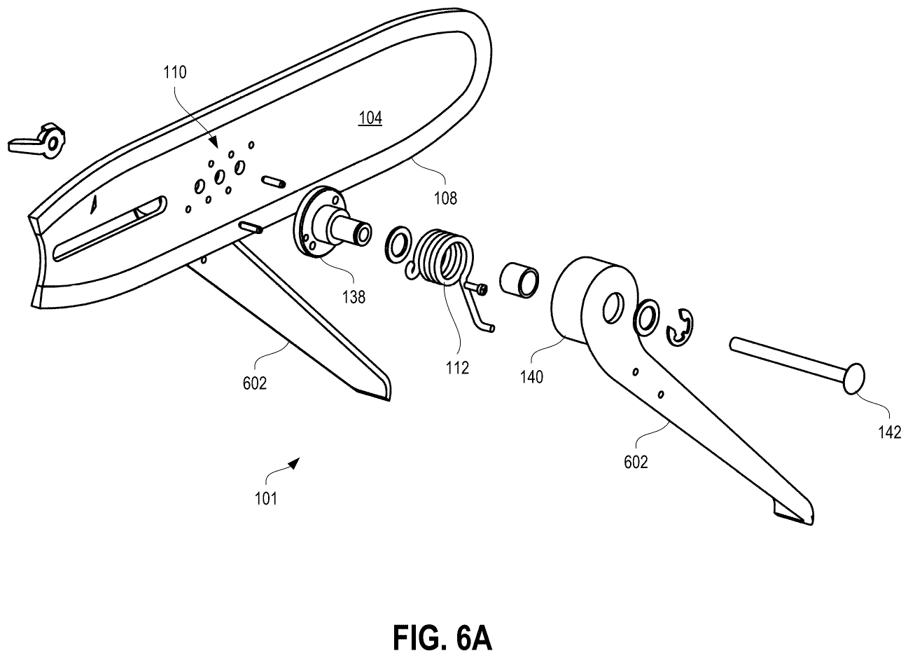

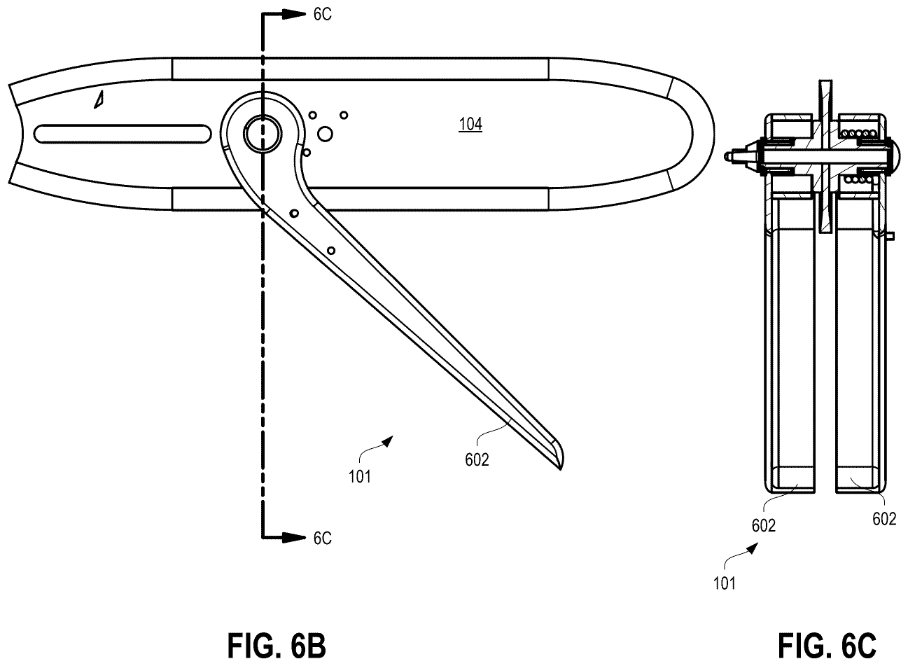

FIG. 6A is an exploded view of an apparatus coupled to a guide 104, in accordance with an embodiment.

FIG. 6B is a side elevation view of the apparatus of FIG. 6A coupled to the guide 104, in accordance with an embodiment.

FIG. 6C is a cross-sectional view along the section 6C-6C in FIG. 6B, in accordance with an embodiment.

Referring to FIGS. 6A-6C, arms 602 may be coupled to the guide 104 via a single spring 112. The spring 112 may have a first end distal from the guide 104, e.g. a first terminal end, affixed to an arm 602, which may define an integrated spring cap 140 for receiving such an end of the spring 112, e.g. the spring cap 140 be in unitary construction with the rest of the arm 602 and may extend axially towards the guide as a flange defining a hollow or cavity for receiving the spring 112. The spring 112 may have a second end proximal to the guide 104, e.g. a second terminal end, affixed to a mounting hub 138.

An elongated bolt 142 may be engaged with and retained in the arms 602 (or spring cap 140 thereof), spring 112, mounting hub 138, and guide 104, e.g. by means of hardware as shown. Hardware may include wingnut(s), machine screw(s) (e.g. cross recessed fillister head machine screws), retaining ring(s) (external retaining rings), bushing(s), and pin(s) (slotted spring pins as shown in the exploded view between the guide and the mounting hub 138). In various embodiments, the elongated bolt 142 may retain, or couple, the arms 602 to each other and to the spring for resilient operation. For example, the elongated bolt may hold arm assemblies (containing the mounting hub 138, spring 112, spring cap 140, sleeve, washers, retaining rings) together onto the guide 104.

A plurality of apertures may be provided on the guide 104 to allow selective positioning of the pivot 110.

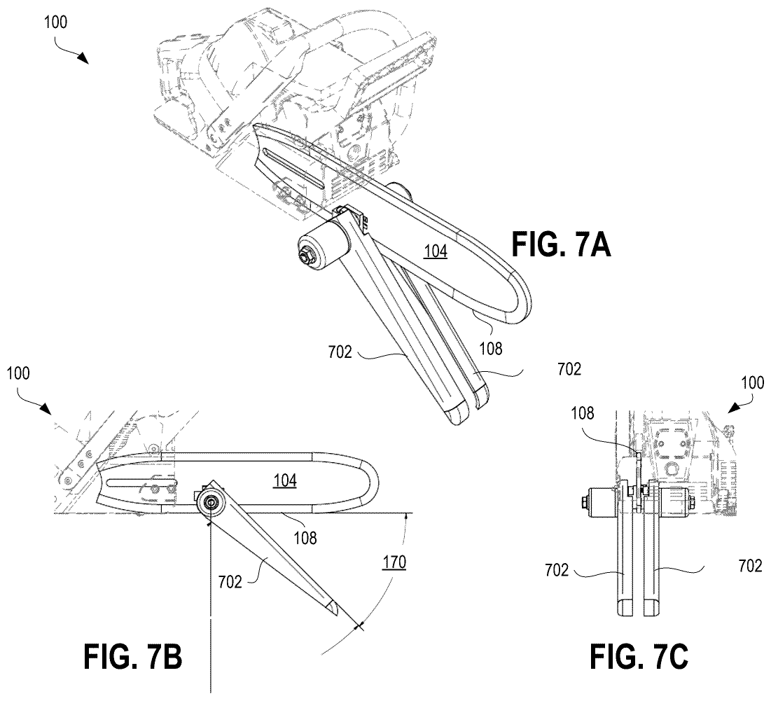

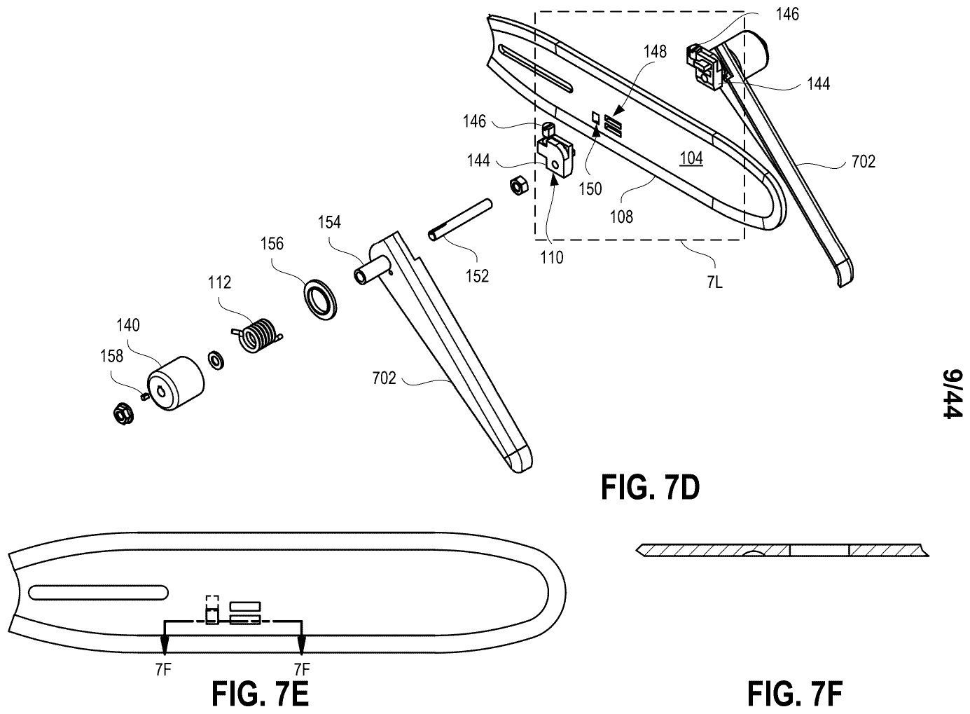

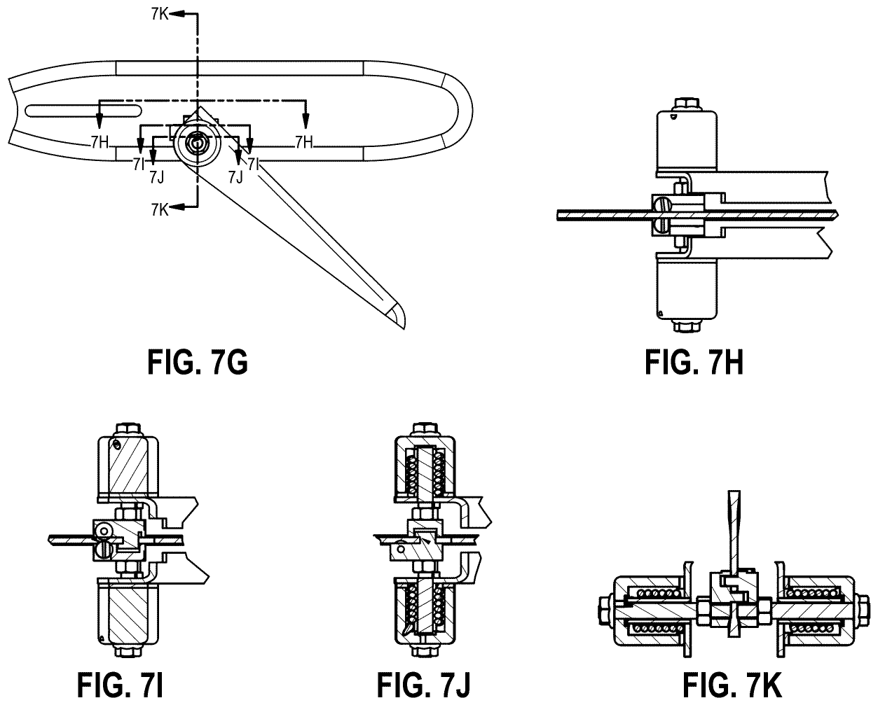

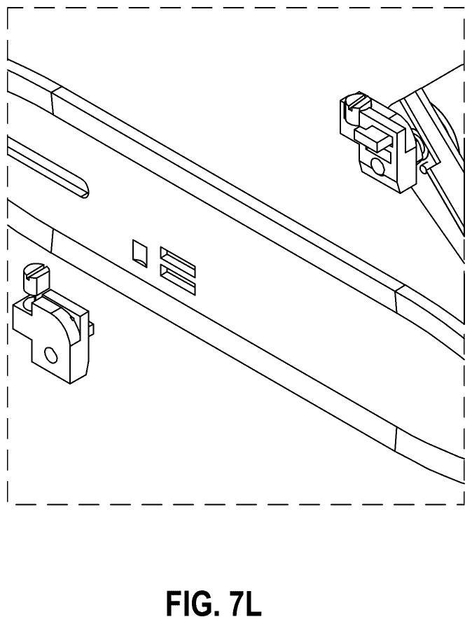

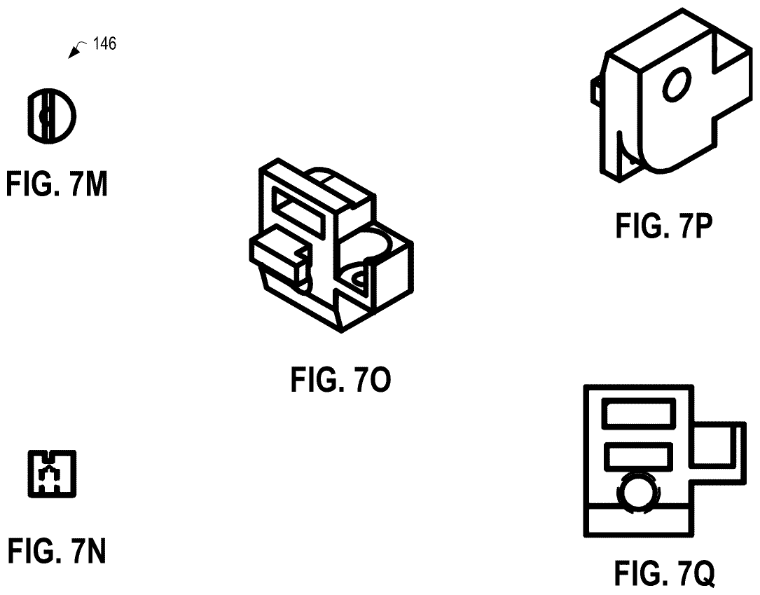

FIG. 7A is a perspective view of a system 100 for cutting an object, in accordance with an embodiment.

FIG. 7B is a side elevation view of the system 100 of FIG. 7A, in accordance with an embodiment.

FIG. 7C is a front elevation view of the system 100 of FIG. 7A, in accordance with an embodiment.

FIG. 7D is an exploded view of the system 100 of FIG. 7A, in accordance with an embodiment.

FIG. 7E is a side elevation view of the cutting blade of FIG. 7A, in accordance with an embodiment.

FIG. 7F is a cross-sectional view along the section 7F-7F in FIG. 7E, in accordance with an embodiment.

FIG. 7G is a side elevation view of a portion of the system 100 of FIG. 7A, in accordance with an embodiment.

FIG. 7H is a cross-sectional view along the section 7H-7H in FIG. 7G, in accordance with an embodiment.

FIG. 7I is a cross-sectional view along the section 7I-7I in FIG. 7G, in accordance with an embodiment.

FIG. 7J is a cross-sectional view along the section 7J-7J in FIG. 7G, in accordance with an embodiment.

FIG. 7K is a cross-sectional view along the section 7K-7K in FIG. 7G, in accordance with an embodiment.

FIG. 7L is an enlarged view of the region 7L-7L in FIG. 7D, in accordance with an embodiment.

FIG. 7M is a top plan view of a dog 146, in accordance with an embodiment.

FIG. 7N is a side elevation view of the dog 146, in accordance with an embodiment.

FIG. 7O is a perspective of a piece of a two-piece clamp 144, in accordance with an embodiment.

FIG. 7O is a perspective of a piece of a two-piece clamp 144, in accordance with an embodiment.

FIG. 7O is a perspective of a piece of a two-piece clamp 144, in accordance with an embodiment.

FIG. 7P is another perspective view of the piece of the two-piece clamp 144, in accordance with an embodiment.

FIG. 7Q is a side elevation view of the piece of the two-piece clamp 144, in accordance with an embodiment.

The system 100 shown in FIGS. 7A-7L may be a quick connect system. For example, the system 100 may allow an operator to rapidly mount/install arms 702 on to the guide 104 and to rapidly unmount/uninstall the arms 702 from the guide 104.

A two-piece clamp 144 may define a first piece disposed on a first side of the guide 104 and a second piece disposed on a side of the guide 104 opposite thereto. The first and second pieces of the clamp 144 are configured to engaged with each through the guide 104 so as to clamp on to the guide 104 on both sides thereof. The first and second pieces of the clamp 144 may thereby, or partially thereby, be held in place relative to the guide 104.

Advantageously, in some embodiment, the first and second pieces of the clamp 144 may be configured to interlock with each other or hook on to each other via openings 148 or apertures in the guide 104 configured to allow one piece to access the other piece. For example, this may allow readily aligning pieces with one another across the guide 104. For example, the openings 148 may include two openings, or two rectangular openings formed in the guide 104. A user may conveniently insert the pieces through the apertures and push them against each other to cause their interlocking or hooking portions to engage with one another to form the clamp 144. In some embodiments, a protrusion of the first piece passing through the guide 104 engages with a corresponding depression of the second piece and a protrusion of the second piece passing through the guide 104 engages with a corresponding depression of the first piece.

In some embodiments, the clamp 144 may further be held in position by engagement or attachment to the guide 104. For example, in FIGS. 7A-7L, each piece of the clamp 144 is configured to receive a corresponding dog 146 (or detent) therein to be held in-place (locked) relative to the piece while allowing rotation thereof about a fixed axis. Each dog 146 may be elongated along its fixed axis so as to define a tubular or cylindrical shape. Each dog 146 may include a corresponding arcuate or partially circular outer perimeter, or cross-section normal to the fixed axis, defining a partially circular portion and a portion that is flat or subcircular relative to the partially circular portion (i.e. lies within a circle that may be formed by extending the partially circular portion of the outer perimeter). The partially circular portions of the dogs 146 may be complementary to corresponding depressions 150 or grooves formed in the guide 104. Each dog 146 may be adapted to engage with a corresponding depression 150 by being seated therein via its partially circular portion. In such an engaged position, the clamp 144 may further be fixed in place by the dogs 146. Each dog 146 may be disengaged from the guide 104 by rotation of the dog 146 such that the subcircular portion faces the depression 150 and the partially circular portion of the dog 146 is rotated away from the depression 150.

In various embodiments, the depressions 150 may have a partially circular cross-section and/or may be positioned adjacent to the openings 148.

The use of the dog 146 may advantageously allow the openings 148 to be sized to be larger than needed, e.g. precise machining and position may not be necessary thereby improving manufacturability and facilitating ease of deployment, e.g. field deployment.

Once mounted on to the guide 104 each piece of the clamp 144 may be configured to form a pivoting joint with its corresponding arm 702. The two pieces of the clamp 144 may define two independent and separated apertures (see the apertures defining the pivots 110) for engaging with corresponding elongated shaft 152 on each side of the guide 104. Each shaft 152 may be independent of the other. The shafts 152 may be pivotable or rotatably about an axis through the apertures. Each shaft 152 may be engaged with a corresponding spring 112 (e.g. torsion coil spring) to generate a force in response to rotation and may be slidably engaged with a sleeve 154 (or shaft) extending outwardly from a corresponding arm 702. A bushing 156 may be provided. In various embodiments, the bushing 156 may be a slippery bushing (e.g. a nylon bushing) adapted to limit friction between the rotatable arm 702 and (fixed) spring cap 140. As illustrated, a smaller bushing may be provided to engage the end of the sleeve 154 and the inside of the spring cap 140 to reduce friction between these two parts. The spring 112 provides torsional resistance directly between the arm 702 and the spring cap 140. Spring caps 140 may receive corresponding springs 112. Each spring 112 may define opposed terminal ends that engage with the spring cap 140 and the arm 702 to define a resting position of the arms 702. For example, a resting position of the arms 702 may be at 45° (angle 170) rotation away from the guide 104. In various embodiments, the arms 702 may be rotated up to 90° away from the guide 104.

Each shaft 152 may have formed thereon a corresponding keyway configured to engage with a key 158. The shaft 152 may pass through an aperture in the spring cap 140 and may be retained in place by a nut or retainer cap preventing axial movement of the shaft 152 out of the aperture in the spring cap 140. The key 158 may be complementary to a portion of the aperture and may be held in place by the nut or retainer cap. The key 158 may simultaneously engage with the spring cap 140 and the shaft 152 to prevent relative rotation therebetween. For example, the key 158 may be dimensioned so as to provide a stop to rotation of the shaft 152 relative to the spring cap 140. For example, the key 158 may be polygonal, cuboid, or cubic.

As shown in FIGS. 7M-7N, the dog 146 has a fillister head.

As shown in FIGS. 7O-7Q, the piece may comprise a hooked protrusion (e.g. L-shaped protrusion) and a slot or groove for receiving the protrusion from an opposite piece. The protrusion and slots may be stacked on top of each other. A pocket (e.g. slot or groove) may be formed at an end of the piece for receiving the dog 146. A circular aperture defining a hole is formed below the protrusion to for receiving the shaft 152.

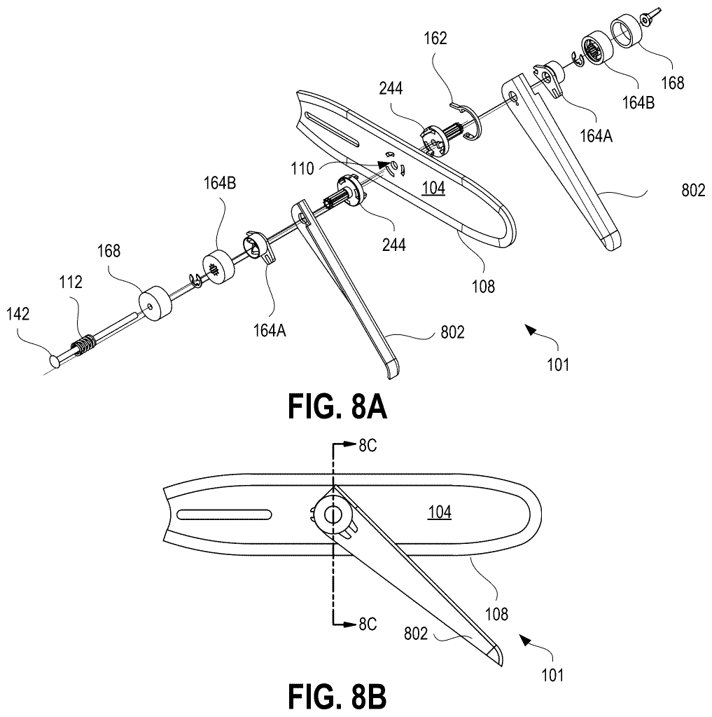

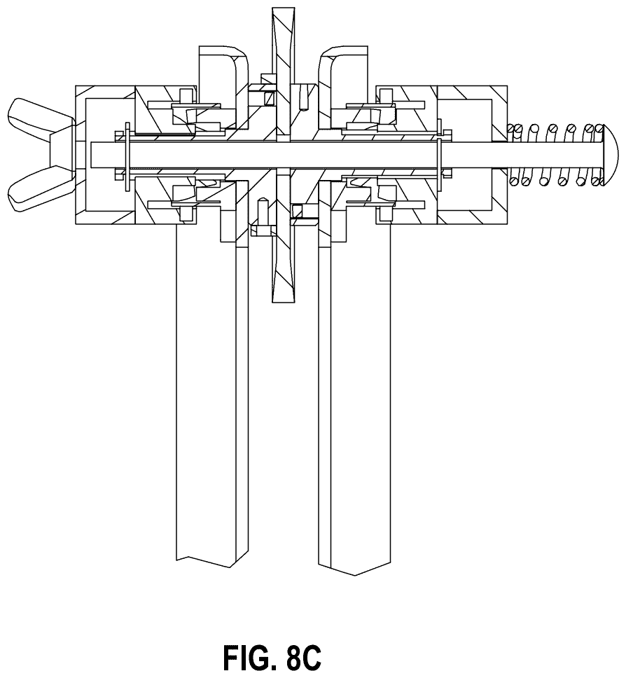

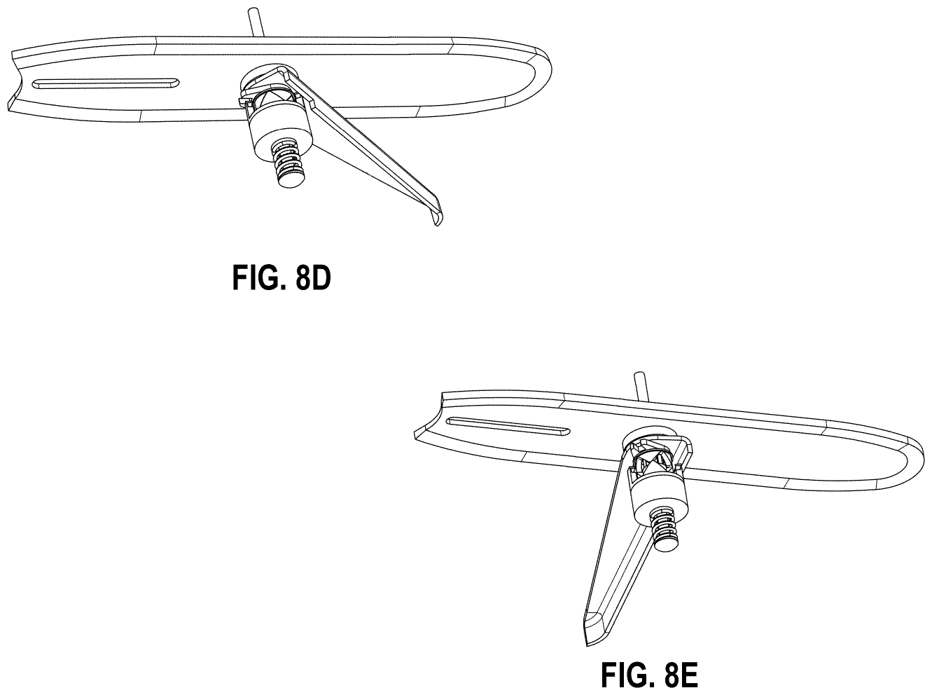

FIG. 8A is an exploded view of an apparatus for a system for cutting an object, in accordance with an embodiment.

FIG. 8B is a side elevation view of the apparatus of FIG. 8A, in accordance with an embodiment.

FIG. 8C is a cross-sectional view along the section 8C-8C in FIG. 8B, in accordance with an embodiment.

FIG. 8D is a perspective partial sectional view of the apparatus of FIG. 8A showing a spring thereof in a relaxed position with cams fully interlocked, in accordance with an embodiment.

FIG. 8E is a perspective partial sectional view of the apparatus of FIG. 8A showing a spring thereof in a compressed position with cams ramping against each other to cause an axial separation therebetween, in accordance with an embodiment.

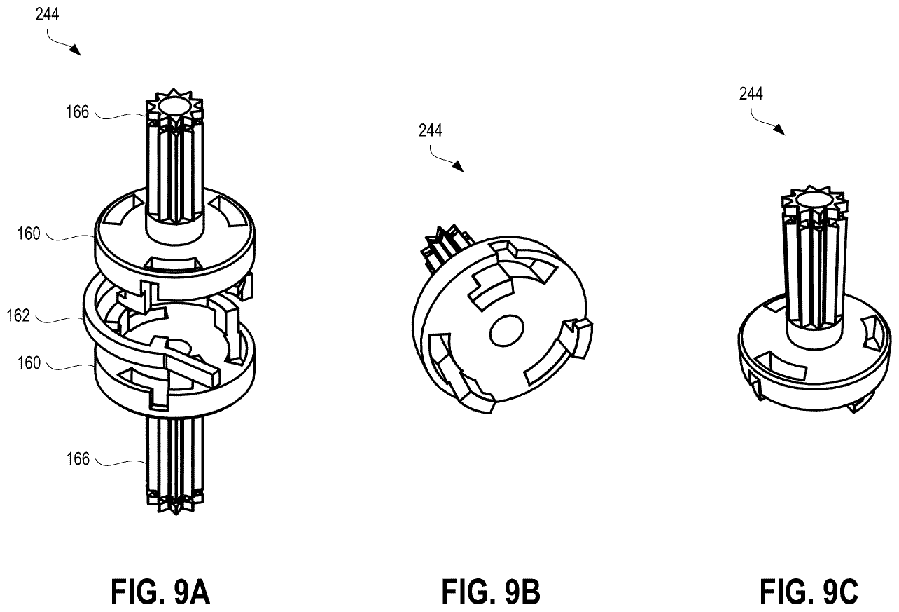

FIG. 9A is a perspective view of a clamp 244 of the system of FIG. 8A, in accordance with an embodiment.

FIG. 9B is a perspective view of the clamp 244 of FIG. 9A, in accordance with an embodiment.

FIG. 9C is a perspective view of the clamp 244 of FIG. 9C, in accordance with an embodiment.

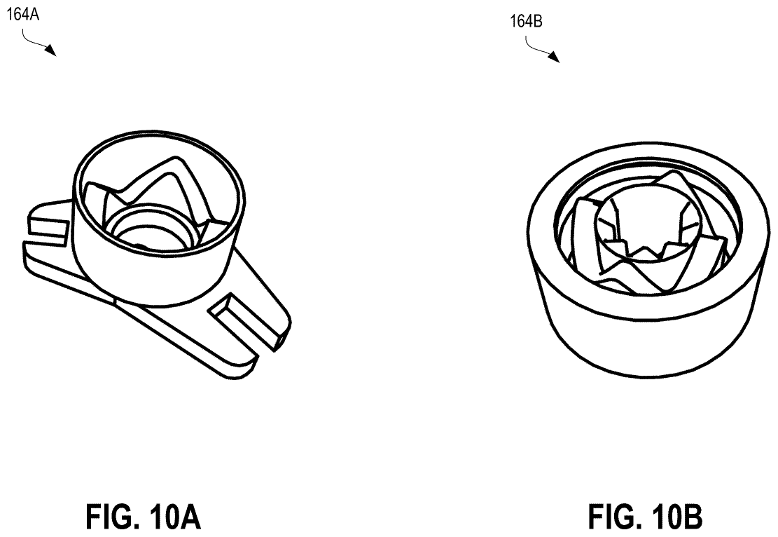

FIG. 10A is a perspective view of a cam 164A, in accordance with an embodiment.

FIG. 10B is a perspective view of a cam 164B, in accordance with an embodiment.

The embodiments in FIGS. 8A-8C show another type of quick connect type of fitting for retaining arms 802 on the guide 104. The arms 802 may be coupled to each other for common rotation about pivot 110. The arms 802 may resiliently pivot about the pivot 110 due to spring force provided by a spring 112, which may be a linear coil spring configured to be compressed along the axis of rotation of the arms 802 as the arms 802 are rotated away from the guide 104.

The arms 802 may have wings extending axially outwardly for engaging with objects to be cut and for providing a lower surface for engaging with components, as described later.

Two separate pieces on opposite sides of the guide 104 may form clamp 244. Each piece of the clamp 244 may comprise protrusion(s) and depression(s) (or slot(s)) for engaging with the opposing piece via apertures formed on the guide 104 around the pivot 110 and an aperture defining the axis of rotation of the arms 802.

Each piece of the clamp 244 may define a substantially circular or cylindrical base 160. The aforementioned protrusion(s) and depression(s), or slot(s), may be formed in the bases 160. Extending from the cylindrical base 160 of each piece may be a corresponding grooved shaft 166 suitable for mating with a corresponding female receptacle. For example, common rotation with the shaft 166 may be achieved thereby. The shaft 166 may be hollow to allow passage of another shaft therein. The hollow interior of the shaft 166 may extend from the shaft 166 to an opposite side of the base 160, i.e. the hollow interior may pass through the piece to allow rotational engagement of the piece with another member.

Each piece of the clamp 244 is slidably engaged with a corresponding arm 802 via the corresponding grooved shaft 166 being slidably engaged with an aperture formed in the arm 802. The arms 802 are thereby allowed to pivot about the guide 104.

A first piece of the clamp 244 interlocks with a second piece of the clamp 244 on an opposite side of the guide 104. A retainer 162, e.g. in the form of a band with protrusions complementary to slots in the pieces of the clamp 244, engages with at least one of the pieces to prevent subsequent disengagement, e.g. during operation or use. In some embodiments, the pieces of the clamp 244 are configured to interlock with each other via hook-shaped slots and complementary protrusions suitable for hooking, e.g. cuboid protrusions on one piece may be suitable to be engaged with an L-shaped slot in an opposite piece. The retainer 162 may engaged with hook-shaped slots, e.g. L-shaped slots, to obstruct openings to the slots to prevent protrusions from slipping out of the slots.

On each side of the guide 104, the respective grooved shaft 166 is further slidably engaged with cams 164A, 164B. On each side of the guide 104, a respective cam or cam assembly is formed by cams 164A, 164B. The cams 164A, 164B are shaped or formed such that their rotary motion gives to parts engaged therewith (with the cam assembly) a linear motion along an axis, e.g. a rotation axis of the arms 802. Such linear motion may be subject to spring resistance. The cams 164A are interlocked with corresponding cams 164B. The cams 164A, 164B each define substantially triangular or conical teeth and depressions, oriented in the axial direction, to engage with each other along the axial direction (i.e. along the rotation axis). The teeth and depressions of cams 164A, 164B define cam surfaces that allow ramping of cams against each other. As shown in FIGS. 8D-8E, slippage and/or disengagement of a cam 164A from a cam 164B by rotation of the cams 164A, 164B relative to each other causes axial separation of the cams 164A, 164B away from each other. The cams 164A, 164B may define cylindrical housings that may be coupled to each, e.g. by sliding into one another, to allow engagement of the teeth and depressions with each other.

The cams 164A may define flanges or wings extending radially outwardly from a central position of the cams 164A or from the axis of rotation. As the cams 164A are rotated, the flanges engage with the arms 802 to hinder movement of the arms 802 and/or move the arms 802 to a resting position defined by the resting position of the cams 164A. For example, the cams 164A may engage with the wings of the arms 802, or a lower surface of such wings. As such, the position of the cams 164A may be associated with a position of the arms 802.

The cam 164B may define a grooved aperture complementary to the shaft 166 of the clamp 144 to receive the shaft 166. As such, the cam 164B may be restricted to co-movement with the clamp 244. For example, the cam 164B may be clamped to the guide 104 together with the clamp 244.

Spacers 168 may be engaged with the cams 164B at axially outward ends of the cams 164B. The spacers 168 may have apertures for receiving spring-loaded bolt 142. The bolt 142 may be slidably engaged with the spring 112. The spring 112 may be retained over the bolt 142 by a head of the bolt 142 and the spacer 168 (at opposing ends). The bolt 142 may be slidable through openings in the spacer 168, the cams 164A, 164B (on both sides of the guide 104), the arms 802 (on both sides of the guide 104), and the clamp 244, through the guide 104. The bolt 142 is retained by means of a wingnut at an end of the bolt 142 opposite to the head of the bolt 142. During operation, the bolt 142 may remain substantially non-rotating but may instead move in the axial direction relative to the spacer 168 to deform the spring 112 to generate resiliency in the rotation of the arms 802.

As the arms 802 are rotated away from the guide 104, the cams 164A are rotated along with the arms 802 while the cams 164B is not rotated as they are clamped to the guide 104. The cams 164A and the cams 164B are rotated relative to each other. Such rotation causes slippage and/or disengagement between the cams 164A and the cams 164B. The cam 164B translates axially away from the cam 164A by pushing the spacer 168 axially outwardly. The spacer 168 is acted upon by the spring 112 which is prevented from expansion on one end by the bolt 142. The spacer 168 then transmits a reaction force, generated via spring force by the spring 112, back to the cam 164B, which hinders the relative rotation described above and thereby hinders rotation of the arms 802. The arms 802 are thereby resiliently pivoted about the guide 104.

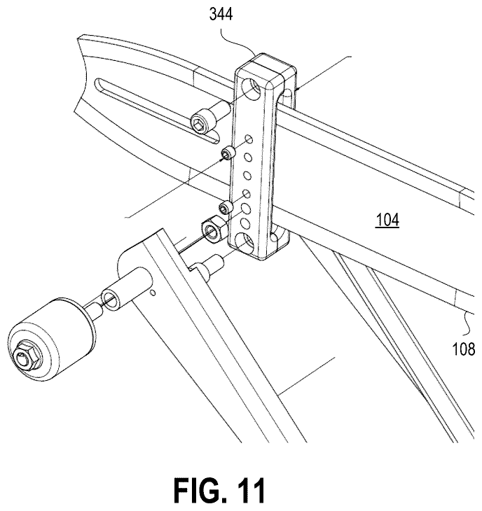

FIG. 11 is a perspective view of a system for cutting an object, in accordance with an embodiment.

The system in FIG. 11 utilizes a two-piece clamp 344 to which arms are coupled, the two piece clamp being clamped to the guide 104 by surrounding the guide 104, e.g. as in a sleeve, to form a bracket. The clamp 344 may allow attachment to existing guides 104 (retrofitting) that may not have pre-existing apertures or holes for coupling. For example, the clamp 344 may provide one or more apertures for coupling (e.g. a series of holes or apertures, such as may be vertically stacked or oriented). In various embodiments, the clamp 344 may comprise two pieces that form an annular rectangular clamp 344 for receiving the guide therein the clamp 344. For example, each piece may be a substantially U-shaped structure. The pieces may be complementary to each other. In various embodiments, the two-piece clamp 344 comprises high-friction inner surfaces to prevent slippage on the guide 104.

In various embodiments, the apertures on the clamp 344 may be spaced apart such that the clamp 344 does not causing crushing and seizure of the chain around the guide 104.

In some embodiments, the clamp 344 may comprise high-friction surfaces for frictionally engaging with the guide 104 to prevent slippage between the clamp 344 and the guide 104. For example, inner surfaces (surfaces of U-shaped structures of the clamp 344) may be high-friction surfaces.

The various systems for cutting objects described comprise arms mounted on to chainsaw-type rotary cutting devices. It is understood that embodiments of systems for cutting objects may be formed with other types of cutting devices. As described further, such cutting devices may include grinders, cutters, or brush saws. In such cutting devices, a substantially circular blade (defining a cutting edge) achieves cutting by being rotated about a spindle. As a referred to herein, a guide of a grinder or brush cutter may refer to a central assembly or structure (e.g. a disc guard) to which the rotating cutting blade is attached, analogous to a guide bar of a chainsaw. For example, such a central assembly or structure may be substantially non-rotating (at least when compared to the cutting edge 108).

In some embodiments, a single piece clamp may be used. The single piece clamp may have an aperture pass therethrough. The single piece clamp may be frictionally held in-place on the guide bar through high friction connections. For example, the single piece clamp may comprise pointed set screws for frictionally engaging with the guide bar.

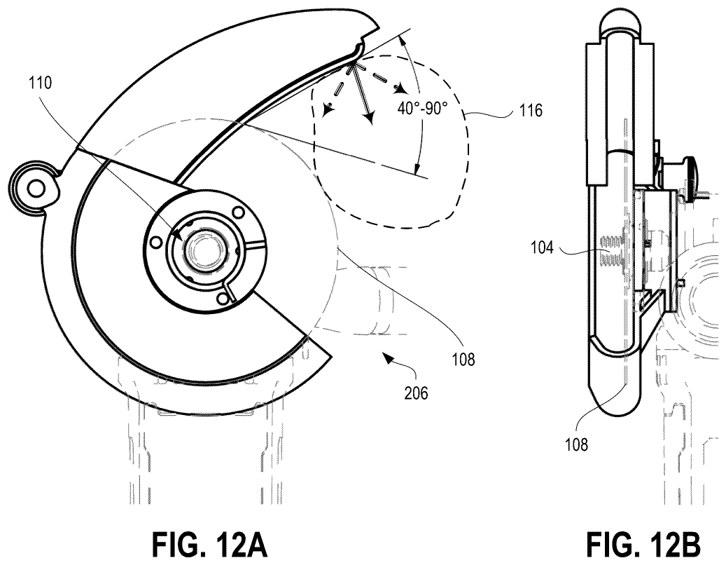

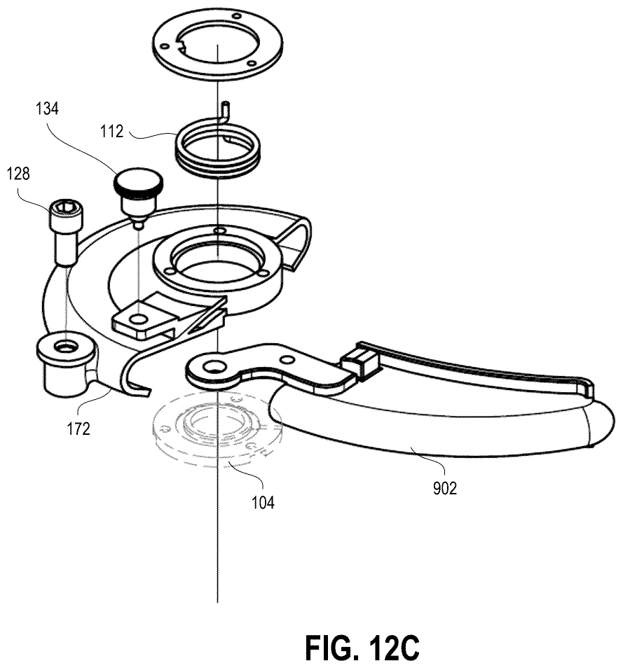

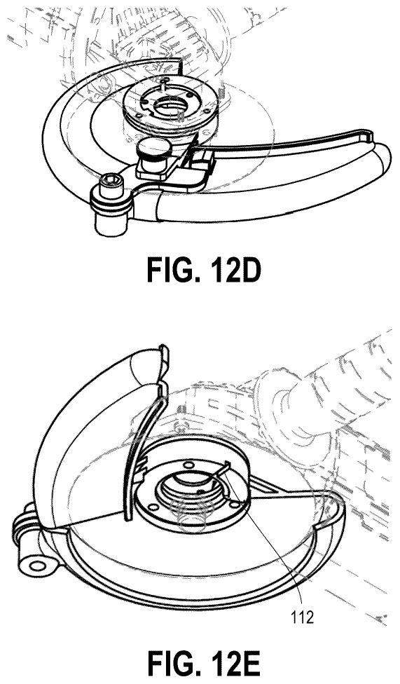

FIG. 12A is a side elevation view of a system for cutting objects, in accordance with an embodiment.

FIG. 12B is a front elevation view of the system of FIG. 12A, in accordance with an embodiment.

FIG. 12C is an exploded view of the system of FIG. 12A, in accordance with an embodiment.

FIG. 12D is a top perspective view of the system of FIG. 12A, in accordance with an embodiment.

FIG. 12E is a bottom perspective view of the system of FIG. 12A, in accordance with an embodiment.

Referring to FIGS. 12A-12E, a cutting device 206 has mounted thereon on an arm 902 for exerting a force against an object 116 being cut by a cutting edge 108 of a cutting blade of the cutting device 206. The cutting device 206 may be a grinder, cutter, brush cutter, brush saw or other type of rotary cutting device.

The arm 902 is coupled to a fence 172 (for coupling to the cutting device similar to the coupling bar) via (at least or only) two spatially separate (or non-coincident) fasteners 128, 134. The fence 172 may act as a guard. Each of the fasteners 128, 134 may independently form a revolute joint between the arm 902 and the fence 172. As such, when both are engaged, the arm 902 is fixed for relative movement together (or co-movement) with the fence 172. The fastener 134 may be a lock pin. In various embodiments, the fastener 134 may be removable by a user or operator so as to allow rotation of the arm 902 away from the cutting edge 108 to allow disengagement or to prevent engagement of the object 116 with the arm 902, e.g. as earlier described with reference to the embodiment of FIGS. 4A-4B. When desired by a user or operator, the arm 902 may be engaged by rotating the arm 902 back into position via rotation about the revolute joint defined by the fastener 128 and the engaging the fastener 134 to join the arm 902 for co-movement with the fence 172 or substantially common movement with the fence 172 or co-rotation therewith around the axis of rotation.

The arm 902 may be mounted on to the guide 104 via the fence 172 (which may act as a guard) and may be configured to resiliently pivot about the pivot 110 together with the fence 172 so as to apply a force on to the object 116. In particular, relative translation of the object 116 onto the cutting edge 108 may push cause rotation of the arm 902 away from the cutting edge 108. In various embodiments, this may then generate a spring force by spring 112, which may be a torsion coil spring, that pushes the arm 902 against the object 116 so as to force it against the cutting edge 108. In various embodiments, the spring is also sufficiently pliable to allow the arm 902 to pivot away for sufficiently large cutting forces, e.g. acting as a shock absorber, which may reduce cutting shock, tool kick back, and/or tool breakage. As shown in FIG. 12A, an example reaction force onto the object 116 may have a component that is directed towards the cutting edge 108.

The arm 902 may be sufficiently wide to extend on both sides of the guide 104 and blade, normal to the blade. For example, two separate arms on opposite sides of the cutting edge 108 may not be thereby needed. In some embodiments, the arm 902 is positioned so that it extends equal amounts on either side of the cutting edge 108.

In various embodiments, the arm 902 may be arcuate, curved, convex, and/or partially circular. For example, the arm 902 may be spaced apart from and be partially circularly shaped based on a circle concentric with the blade and of larger radius than the blade so as to define surface that is spaced apart from and substantially follows the cutting edge 108 at least for a portion thereof.

In various embodiments, the fence 172 may be sized based on an operational size available to a user. For example, a small size fence 172 may be used. The fence 172 may define a hood that covers a portion of the blade to prevent unintentional cutting by the blade. The fence 172 may be particularly useful during remote positioning (e.g. via a boom) since it may be challenging for a user to position the cutting device 206 while avoiding cutting objects that are not to be cut and maintaining safety, e.g. to prevent injury to an operator's digits.

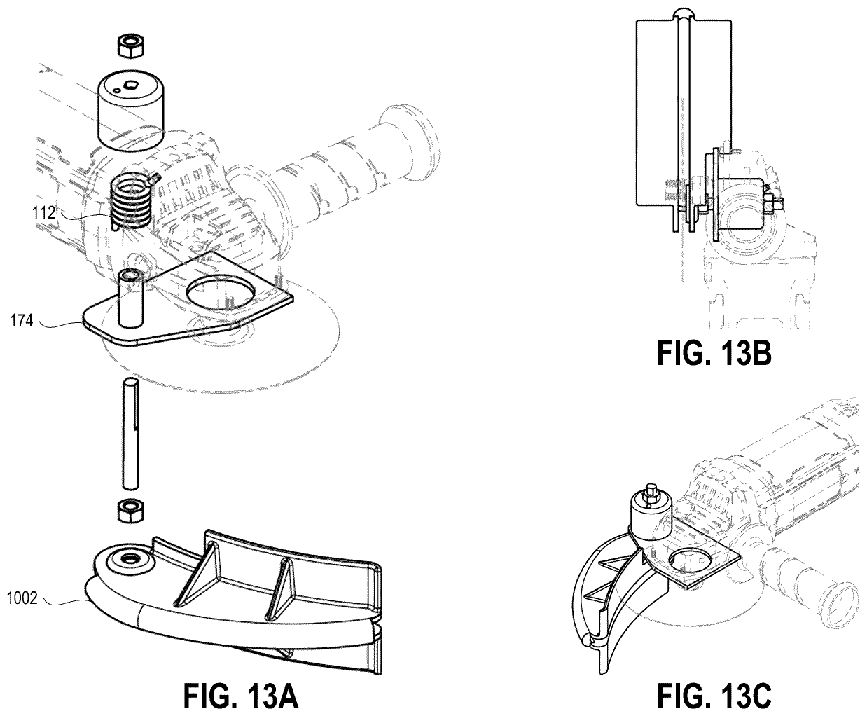

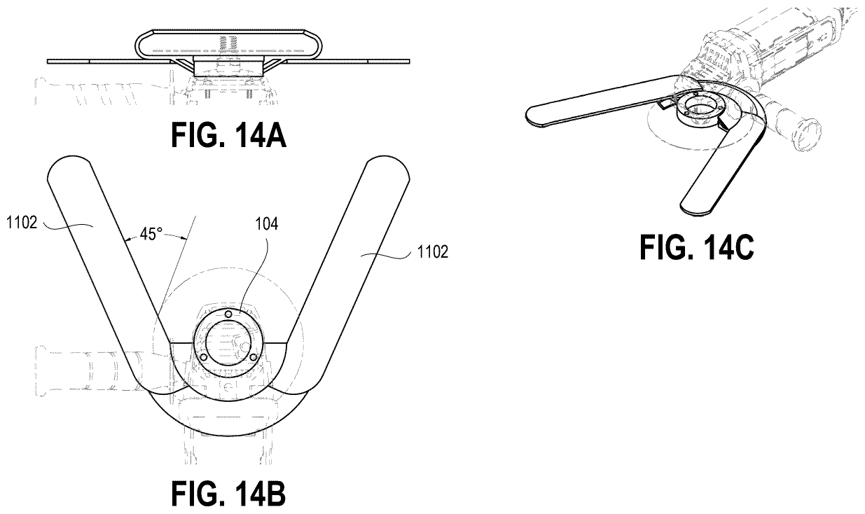

FIG. 13A is an exploded view of a system for cutting objects, in accordance with an embodiment.

FIG. 13B is a front elevation view of the system of FIG. 13A, in accordance with an embodiment.

FIG. 13C is a perspective view of the system of FIG. 13A, in accordance with an embodiment.

Arms 1002 are resiliently attached to the cutting device 206 via a spring 112 for resilient rotation of the arm 1002. The arm 1002 may comprise wings of a wide fence to facilitate cutting, e.g. by pushing against a greater portion of the object 116.

A plate 174 is affixed to the cutting device 206 and defines a space between the blade and the plate 174. In some embodiments, the plate 174 may position and retain the object 116 for cutting.

FIG. 14A is a front elevation view of a system for cutting objects, in accordance with an embodiment.

FIG. 14B is a top plan view of the system of FIG. 14A, in accordance with an embodiment.

FIG. 14C is a perspective view of the system of FIG. 14A, in accordance with an embodiment.

Arms 1102 may be coupled to the guide 104 (e.g. disc guard). The twin arms 1102 may provide a solid anvil for cutting material. For example, the arms 1102 may be rigidly coupled to the guide 104. An object being cut may engage with the arms 1102. The arms 1102 may prevent movement of the object. The object may be pressed against one or more of the arms 1102 during cutting (similar to an anvil). The arms 1102 may provide a reaction force. Deformation of the arms 1102 may generate a reaction force. In various embodiments, the system may be spring-less (spring-free or free of springs) and/or the mounting system may be spring-less (spring-free or free of springs).

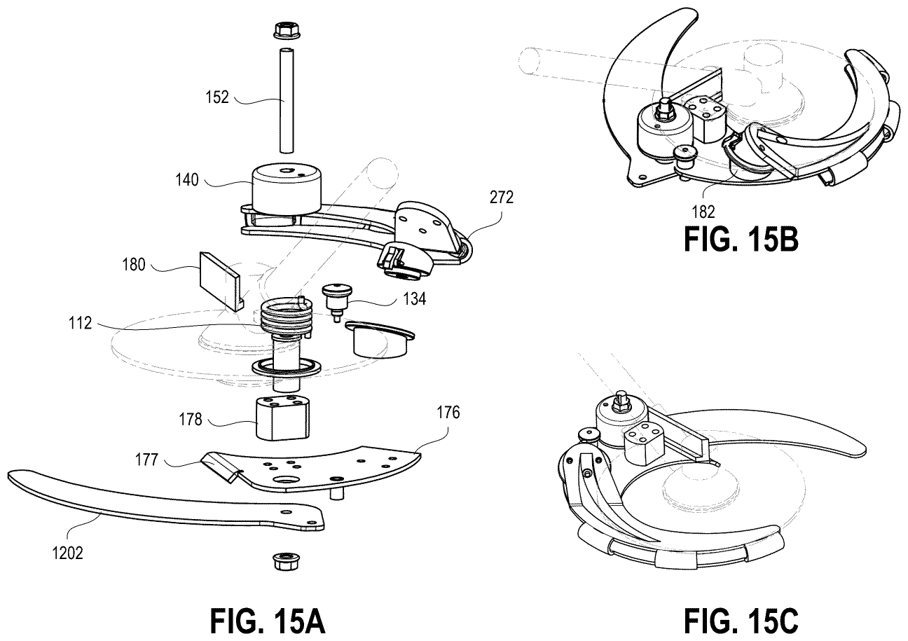

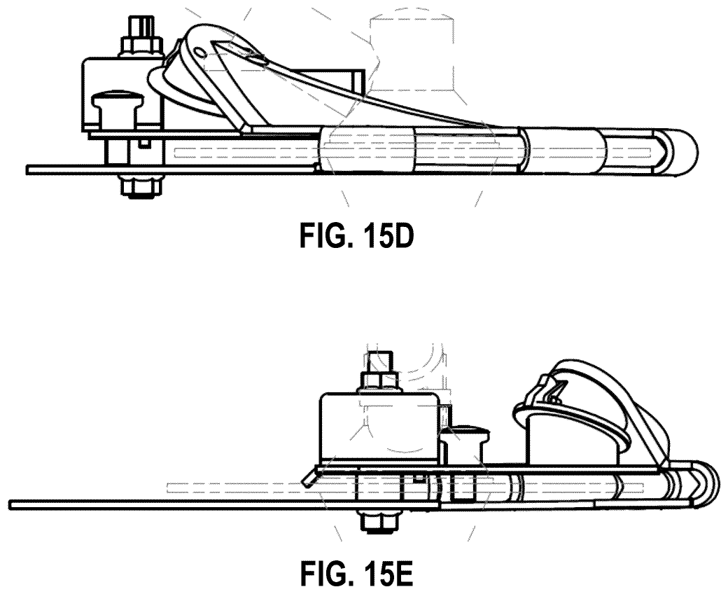

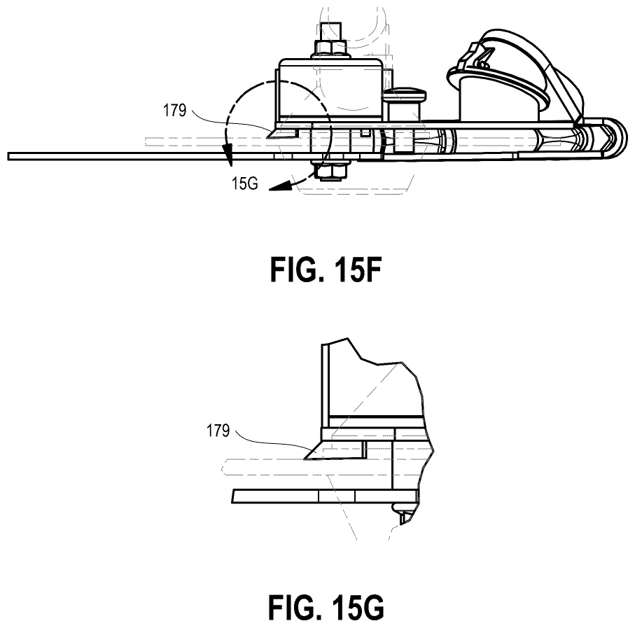

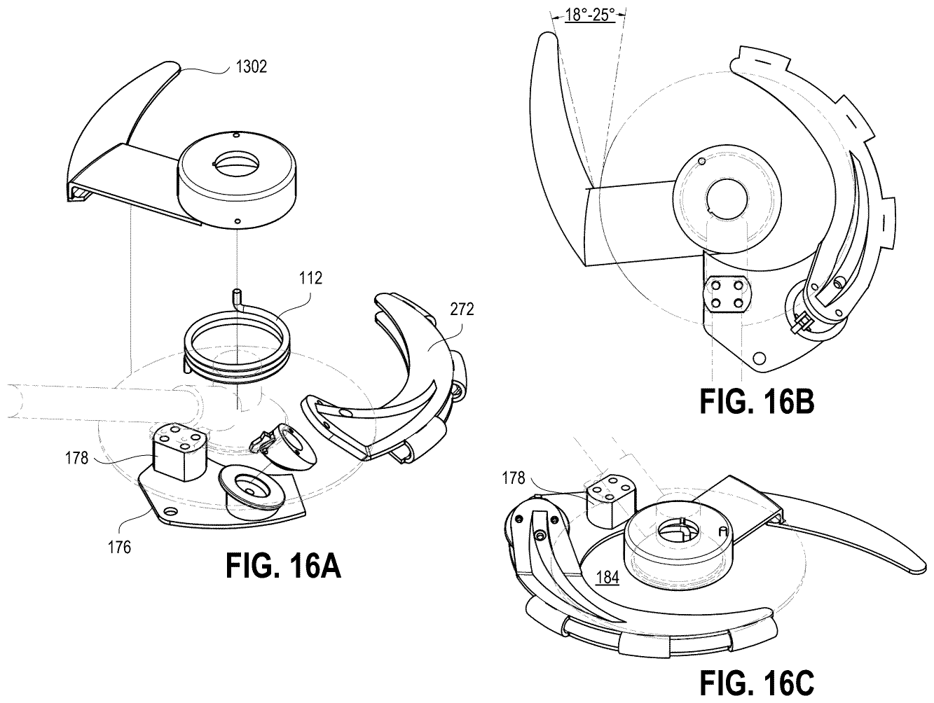

FIG. 15A is an exploded view of a system for cutting objects, in accordance with an embodiment.

FIG. 15B is a perspective view of the system of FIG. 15A, in accordance with an embodiment.

FIG. 15C is another perspective view of the system of FIG. 15A, in accordance with an embodiment.

FIG. 15D is a side elevation view of the system of FIG. 15A, in accordance with an embodiment.

FIG. 15E is another side elevation view of the system of FIG. 15A, in accordance with an embodiment.

FIG. 15F is a side elevation view of the system of FIG. 15A wherein a deformable guard 179 replaces an extension 177 for clearing debris, in accordance with an embodiment.

FIG. 15G is an enlarged view of the region 15G in FIG. 15F.

Referring to FIGS. 15A-15E, arm 1202 is rigidly coupled to a fence 272 via a center plate 176 (or mounting plate). The fence 272 may act as a backside guard. The assembly of the arm 1202, the center plate 176, and the fence 272 is mounted on to a guide 104 of the cutting device via a spring-loaded pivotable joint that generates a reaction spring force (e.g. by means of a torsion spring) so as to facilitate cutting.

The center plate 176 is attached to the cutting device via a standoff 178. For example, the center plate 176 may be fixed or rigidly attached to the standoff 178. In some embodiments, the standoff 178 is attached to an elongated rod of the cutting device, as illustrated in FIGS. 15B-15C. The elongated rod may be a guide of the cutting device. A guard 180 may be positioned adjacent to the standoff 178 to prevent interference of componentry with the rod. The guard 180 may be brush and debris guard. For example, the guard 180 may advantageously mitigate debris buildup in an area adjacent (e.g. surrounding) the standoff 178, during or due to cutting.

The center plate 176 defines the extension 177 positioned to displace cut debris away from the cutting device, cutting edge, and/or the guide. The ledge extends over the cutting edge and a surface adjacent to the cutting edge (surface of the cutting blade) at an end of the cutting edge so as to displace debris being moved toward the end by the rotary movement of the cutting edge. In various embodiments, the extension 177 may be a ledge, and/or a protrusion. The extension 177 may be angled so as to direct debris away from the cutting edge.

The extension 177 may be angled outwards such that rotation of the saw causes the grass scraper to sheer the grass out towards the outer rim of the saw.

In some embodiments, as shown in FIGS. 15F-15G, a deformable guard 179 or scraper made of material such as nylon or UHMW may be fastened under a flat center plate at that same location to provide a similar function.

A fastener 134 may engage the arm 1202 with the center plate 176. In various embodiments, the fastener 134 may be a removable fastener, e.g. such as a lock pin or spring-loaded pin. FIG. 15B shows the fastener 134 engaged with the center plate 176 and not engaged with the arm 1202. The arm 1202 may be rotated away from cutting edge 108 such that an aperture on the arm 1202 (shown in FIG. 15B) is coincident with an aperture on the center plate 176 engaged with the fastener 134. The fastener 134 may then be engaged with both (at the same time) the arm 1202 and the center plate 176 to lock the arm 1202 in an open position.

The fence 272 may be coupled to the center plate 176 independently of the arm 1202. The fence 272 may be coupled to the center plate 176 via an angled rotary block 182. In some embodiments, the fence 272 may be rigidly fixed to the center plate 176. The angled rotary block 182 may allow rotation of the fence 272 relative to the center plate 176. In various embodiments, such rotation may be along an axis that is non-parallel to a rotation axis of the arm 1202 about the center plate 176. A lock pin on the angled rotary block 182 may maintain the fence 272 (or guard) in an open or closed position. Rotation of the fence 272 may allow it to be moved out of the way during operation by a user.

In some embodiments, the fence 272 may be provided with one or more openings to release debris. For example, open slots may extend or be distributed around a circumference of the fence 272 to allow debris, such as cut grass, to escape radially out through the guard.

The spring 112 may be engaged or rigidly coupled to a spring cap 140. The spring cap 140 may be keyed and may be complementary to shaft 152 such that a key engaged with the spring cap 140 and shaft 152 ensures common rotation of the spring cap 140 and the shaft 152. The shaft 152 may also be engaged with the arm 1202 for common rotation therewith. As such rotation of the arm 1202 may cause torsion in the spring 112 since one end thereof may remain stationary with the center plate 176 while the other end may be coupled for common rotation with the arm 1202.

FIG. 16A is an exploded view of a system for cutting objects, in accordance with an embodiment.

FIG. 16B is a top plan view of the system of FIG. 16A, in accordance with an embodiment.

FIG. 16C is a perspective view of the system of FIG. 16A, in accordance with an embodiment.

Referring to FIGS. 16A-16C, a fence 272 may be coupled to a center plate 176. Arm 1302 may be directly coupled to a central guide of the cutting device and may not be coupled to the center plate 176.

The arm 1302 may comprise a first section extending radially outwardly from a hub of the cutting device and a second portion that is normal thereto and angled between 18° and 25° parallel to the cutting edge 108.

The fence 272 and the center plate 176 may be adapted to form a gullet 184 between the fence 272 and the hub or arm 1302 that may be sufficiently wide to release bypassing debris during cutting. For example, the gullet 184 may be defined by an arcuate portion of the fence 272 and center plate 176.

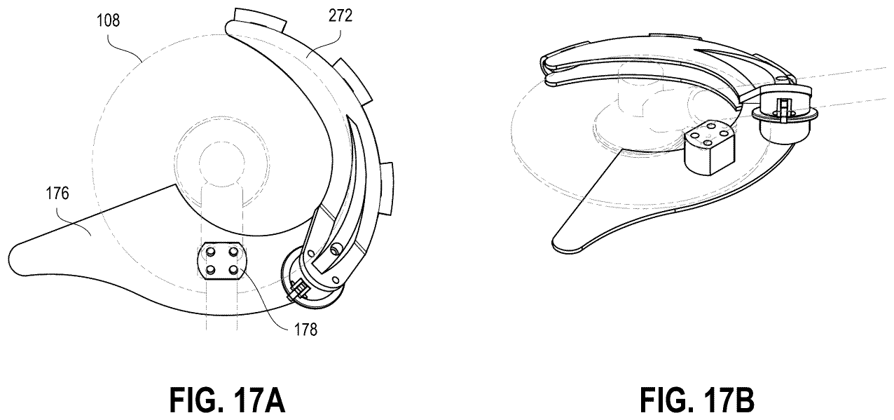

FIG. 17A is a top plan view of a system for cutting objects, in accordance with an embodiment.

FIG. 17B is a perspective view of the system of FIG. 17A, in accordance with an embodiment.

The system may comprise a center plate 176, coupled to the fence 272, that has an extension that forms an arm at least partially around the cutting edge 108. For example, in various embodiments, the system may not comprise a separate arm coupled to the center plate 176 as previously described.

Various other embodiments are conceived to be encompassed within the scope of the present technology. For example, in some embodiments, an arm may be pivoted on the guide and may extend on both sides of the pivot so that a first terminal portion of the arm may be positioned above the guide while a second terminal portion of the arm may be positioned below the guide. In some embodiments the first terminal portion may be resiliently coupled to the cutting device to cause resilient pivoting of the arm. For example, the first terminal portion may be coupled to the cutting device via one or more resilient members, e.g. spring(s) or bungee cord(s). Two such arms may be provided on respective opposite sides of the guide, which two arms may be coupled to a common resilient member affixed or coupled to the cutting device, or which two arms may be coupled to respective separate resilient members affixed or coupled to the cutting device. In some embodiments, a bungee cord may be coupled to an arm via a hook fastener hooked on to the arm, e.g. via a pin rigidly coupling two or more arms to each other. The hook fastener may be coupled to the bungee cord by engagement with a portion of the bungee cord defining a knot (or other enlarged portion) that prevents passage of the portion of the bungee cord out of a receiving port of the hook fastener due to abutment of the knot (or other enlarged portion) against the receiving port. The bungee cord may be wrapped around the cutting device, tied to the cutting device, and/or otherwise frictionally engaged with the cutting device.

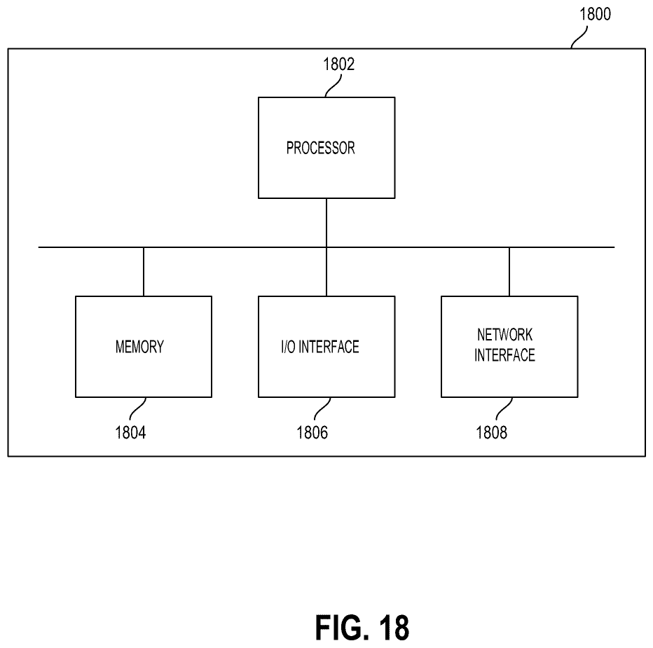

FIG. 18 illustrates a block diagram of a computing device 1800, in accordance with an embodiment of the present application.

As an example, a control system or controller for the actuator (e.g. motor) in FIG. 5A-5B may be implemented using the example computing device 1800 of FIG. 18.

The computing device 1800 includes at least one processor 1802, memory 1804, at least one I/O interface 1806, and at least one network communication interface 1808.

The processor 1802 may be a microprocessor or microcontroller, a digital signal processing (DSP) processor, an integrated circuit, a field programmable gate array (FPGA), a reconfigurable processor, a programmable read-only memory (PROM), or combinations thereof.

The memory 1804 may include a computer memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM).

The I/O interface 1806 may enable the computing device 1800 to interconnect with one or more input devices, such as a keyboard, mouse, camera, touch screen and a microphone, or with one or more output devices such as a display screen and a speaker.

The networking interface 1808 may be configured to receive and transmit data sets representative of the machine learning models, for example, to a target data storage or data structures. The target data storage or data structure may, in some embodiments, reside on a computing device or system such as a mobile device.

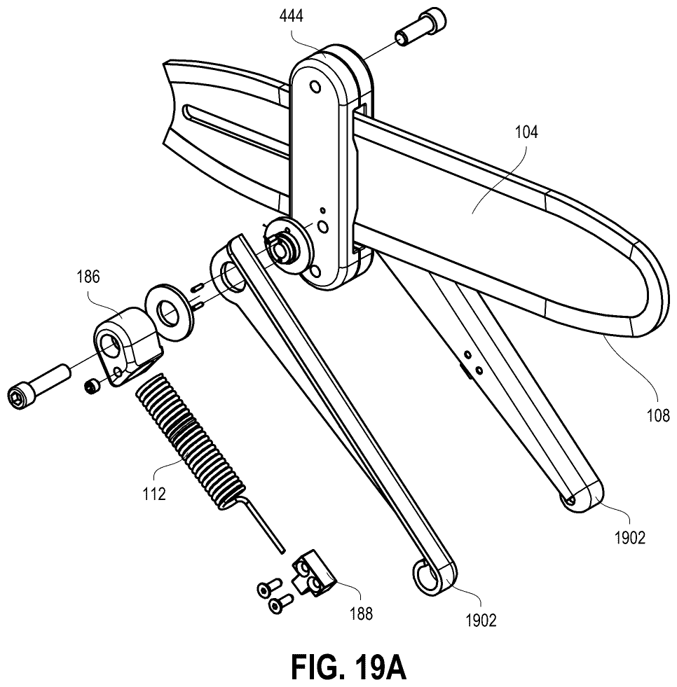

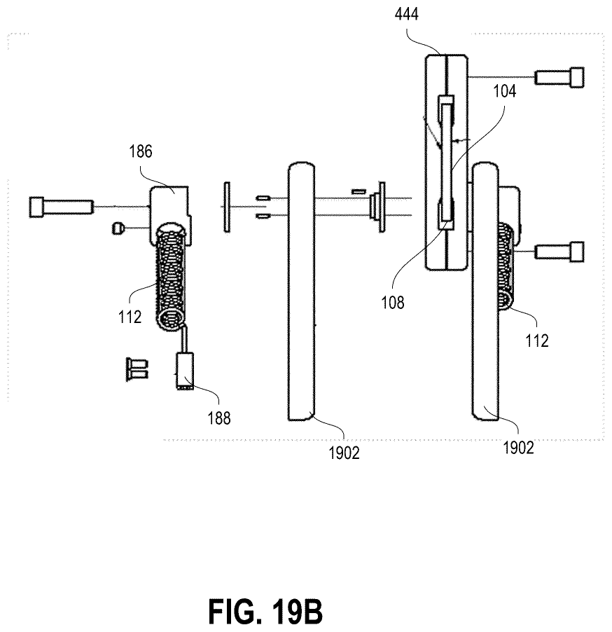

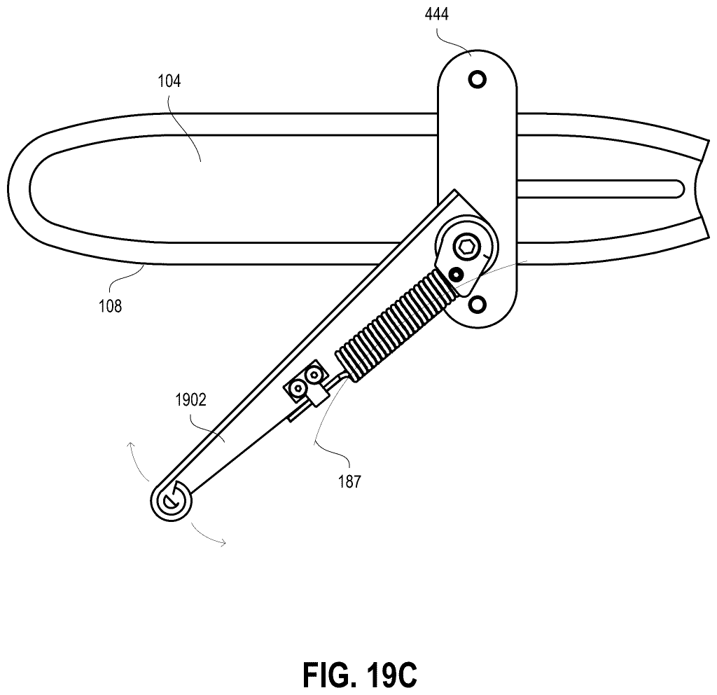

FIG. 19A is a partially exploded front perspective view of a system for cutting objects, in accordance with an embodiment.

FIG. 19B is a front plan view of the system of FIG. 19A, in accordance with an embodiment.

FIG. 19C is a side elevation view of the system of FIG. 19A, in accordance with an embodiment.

Referring to FIGS. 19A-19C, a two-piece clamp 444, similar in some respects to the two-piece clamp 344 of FIG. 11, surrounds the guide 104 lateral to the cutting edge 108 to clamp onto the guide 104 to form a (mounting) bracket. A gap may be formed between opposite pieces of the two-piece clamp 344. An intermediate portion of the clamp 444 may be frictionally engaged with the guide 104, or a face thereof. Outer ends of the clamp 444 may be configured to allow engagement of two separate pieces of the clamp 444 directly with each other, and/or coupling of the two separate piece to each other. As shown in FIGS. 19A-19C, the outer ends may be fastened to each other by means of a bolt that is received through apertures formed in the two separate pieces of the clamp 444. Advantageously, the two separate pieces may be engaged, coupled, or fastened to each other without the guide 104 intervening therebetween around the fastening position. For example, a more secure fit may thereby be achieved and undesirable stress concentrations (as may occur around fasteners) in the guide 104 may be reduced. In various embodiments, clamp 444 surrounds and is squeezed onto the guide 104 by force exerted through the use of two bolts which attach the clamp pieces around the top and bottom of the guide 104.

In various embodiments, locking pins may be provided to lock a pivot (or housing thereof) of the arms to the guide 104, and to lock a spring housing to the pivot (or a housing thereof).

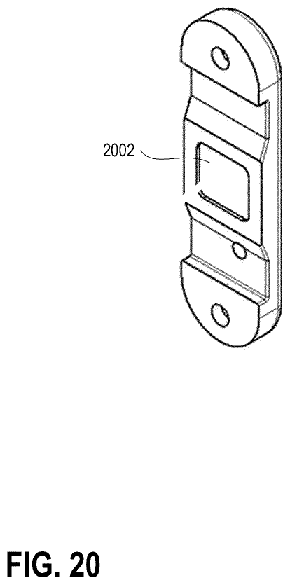

FIG. 20 is a perspective view of one piece of the two-piece clamp 444 used in the system of FIG. 19A, in accordance with an embodiment.

In various embodiments, a gap may be provided at the interface (or in-between) of the two pieces of the clamp 444 (where the bolts are located) such that force is exerted from the clamp onto the face of the guide 104. As shown in FIG. 20, in some embodiments, a shallow pocket 2002 may be formed in one or both pieces of the clamp 444. Such a pocket 2002 may be formed on a face or part of the piece (referred to as the friction face of the piece) that is configured to engage with the guide 104 (a face thereof). Advantageously, this may increase pressure of the friction face on the guide 104. Furthermore, this may allow for the insertion of a friction tape into the pocket 2002 for adjusting or augmenting the frictional force with which the guide 104 is engaged with the clamp 444. The pocket 2002 may also limit creep of the material.

In various embodiments, one or more springs 112 may be provided for resisting rotation of arms 1902 that are pivotably coupled to the guide 104. For example, as shown in FIG. 19B, a spring 112 may be provided on each side of the guide 104. The spring 112 may be elongated, e.g. the spring 112 may a linear tension or compression spring. In some embodiments, the spring 112 may be a flat spring, such as a leaf spring.

In some embodiments, the spring 112 may define a central axis along which the spring 112 extends. The spring 112 may be configured to resist deformation when stretched or compressed along the central axis. For example, the spring 112 may be helically coiled around the central axis. It is understood that the spring 112 may resist deformation in other directions, e.g. the spring 112 may resist bending away from the linear central axis. In some embodiments, the spring 112 may be fully compressed.

The spring 112 may be integrally coupled to a non-rotating spring housing 186, e.g. the spring may be fastened thereonto or locked thereinto by frictionally engagement. In the embodiment of FIGS. 19A-19C, a setscrew clamps radially onto the coil of the spring 112 via a slot formed in the spring housing 186 so as to couple or integrally couple the spring housing 186 to the spring 112. A first end of the spring 112 may be locked onto the spring housing 186 in such a manner.

The spring housing 186 may be attached to the clamp 444, e.g. around the pivot. In some embodiments, the spring housing 186 may be attached to the arm(s) 1902 around the pivot such that the arm 1902 is allowed to rotate around the pivot without rotation of the spring housing 186, e.g. the spring housing 186 may be supported by a bearing attached to the arm 1902 or the arm 1902 may be supported by a bearing attached to the spring housing 186. In some embodiments, the spring housing 186 may be held stationary relative to the clamp 444. In various embodiments, the arms 1902 and the spring housing 186 may be constrained relative to the clamp 444 via a common bolt. Additionally, the spring housing 186 may be rotationally arrested relative to the guide 104 via one or more set pins, as illustrated. As such, the spring housing 186 may be configured to remain substantially stationary relative to the guide 104.

The pivot provides a rotational pivot around which the arms 1902 rotate. In various embodiments, a frictionless washer may facilitate rotation of arms 1902. In various embodiments, spring pins and/or dowels provide a rotational lock for the spring housing 186 thus ensuring that the first end of the spring 112 does not rotate in operation.

A second end of the spring 112 may be constrained to rotate with the arms 1902. Since each of opposite ends of the spring 112 is constrained to move with a respective part of the system, such parts of the system moving (translating and rotating) relative to each other, the spring 112 bends laterally when such parts are moved. In FIG. 20, a notional line 187 is shown to illustrate the central axis of the spring 112 after the spring 112 is bent in such a manner due to the rotation of the arms 1902 (as indicated by the arrows in FIG. 19C).

In various embodiments, the first and second ends may be two ends of the spring 112 separated from each other along a direction of elongation of the spring 112. In various embodiments, the first and second ends may be terminal ends of the spring 112 along such a direction.

In various embodiments, the second end of the spring 112 may substantially linear or elongated so as to be received within a slider 188 (or containment block) forming a prismatic joint with the arm 1902. The spring 112 (or the second end thereof) may be slidable within the slider 188 along the arm 1902 but may be constrained from movement lateral to the arm 1902 so as to provide a constraint that causes bending of the spring 112, when the arm 1902 is rotated, in opposition to the rotation. The slider 188 may be fastened onto the arm 1902 or otherwise integrally coupled thereto.

In some embodiments, the second end of the spring 112 may be directly attached to the arm 1902 so as to provide a resistance to rotation of the arm 1902 around the pivot. For example, the second end of the spring 112 may integrally coupled, e.g. fastened, to the arm 1902. In some embodiments, the second end of the spring 112 may be in unitary construction with the arm 1902.

When the arms 1902 are pushed back during normal sawing or cutting operation, the spring 112 may be constrained as it curves (or bends), as indicated in FIG. 20. Forcing the spring 112 into this curvature may generate resistance force onto the arms 1902.

A similar effect may occur when retracting the guide 104 from an entangling brush. The arms 1902 may rotate up towards the guide 104 which may allow easier extraction. The spring 112 may curve in an opposite direction so as to bring the arms 1902 back to their resting position, e.g. at approximately 45°.

In some embodiments, the spring 112 may fastened directly to an arm 1902, e.g. a machine screw may be fastened to the guide 104 through a loop in the spring 112 so as to frictionally engage the spring 112 with the guide 104 (or guide bar) to prevent their movement relative to each other.

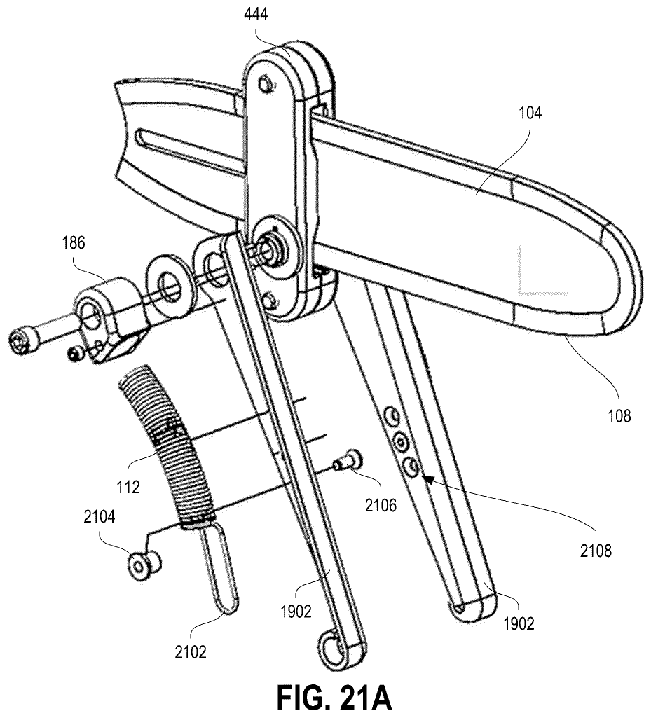

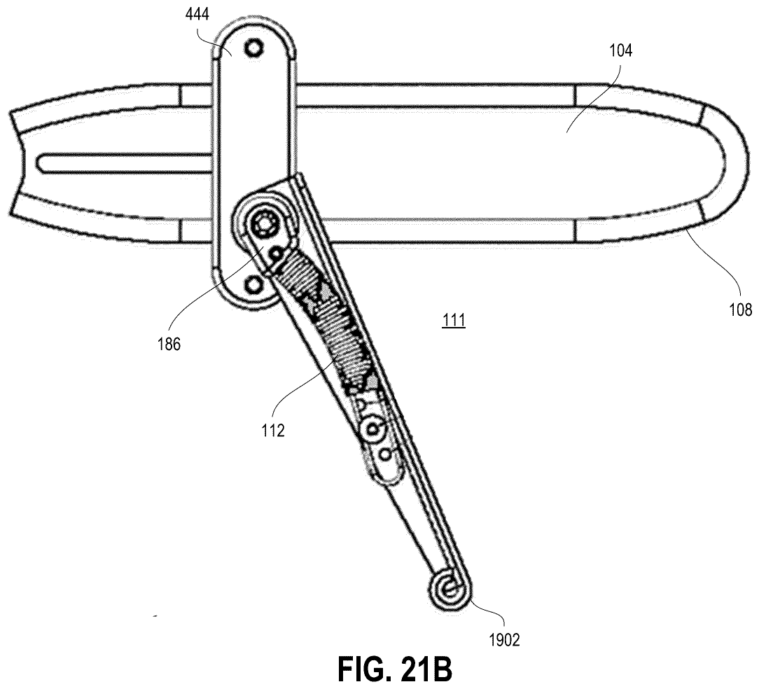

In some embodiments, a spring contact may be provided to contact the spring 112 at an intermediate location in-between the first and second ends thereof. Such a spring contact may extend outwardly from the arm 1902, at least partially parallel to an axis of rotation of the arm 1902, between the spring housing 186 and the slider 188. The spring contact may be configured to abut the spring 112 as the spring 112 bends during rotation of the arm 1902. Advantageously, a normal reaction force applied by the spring contact on to the spring 112 during bending thereof may increase an effective spring stiffness and may mitigate fatigue and/or plastic deformation of the spring 112, such as may be caused by an inadvertently large force applied onto the arm 1902 that would cause bending of the spring 112 beyond its yield point. In various embodiments, the spring contact may be integrally coupled to the arm 1902 (e.g. fastened on to the arm 1902) or in unitary construction therewith. In some embodiments, the spring contact may be a bolt. In some embodiments, the spring contact may be removable and/or selectively positioned relative to the arm 1902. For example, in some embodiments, the spring contact may be selectively received in one of a plurality of apertures, such as those described in reference to FIGS. 21A-21B below, and retainable or fastenable therein.

FIG. 21A is a partially exploded front perspective view of a system for cutting objects, in accordance with an embodiment.

FIG. 21B is a side elevation view of the system of FIG. 21A, in accordance with an embodiment.

The system shown in FIGS. 21A-21B may be substantially similar to the system shown in FIGS. 19A-19C. In the system of FIGS. 21A-21C, the second end of the spring 112 may be shaped to engage with a feature on one or more features extending from the arm(s) 1902. For example, this may involve engagement of an eye or loop 2102 (curved or polygonal) of the spring 112 with a protrusion extending outwardly from the arm(s) 1902. In various embodiments, the second end of the spring 112 may be in unitary construction with the rest of the spring 112. In some embodiments, the second end of the spring 112 may be a wire loop 2102. In various embodiments, the wire loop 2102 may be elongated, e.g. the wire loop 2102 may be elliptical in shape. In some embodiments, the protrusion may be in unitary construction with the arm 1902. In some embodiments, the second end of the spring 112 may receive therein a pin (forming the protrusion) attached to one of the arms 1902. Such a pin may be configured to be received in an aperture 2108 formed in the arm 1902 so as to be retained therein to allow coupling of the spring 112 to the arm 1902. In various embodiments, the pin may be removably coupled to the arm 1902. Such an aperture 2108 may be dimensioned based on an outer dimension of the pin.

In some embodiments, a bolt 2106 may be received in the aperture. Such a bolt 2106 may be configured to couple with a roller 2104, e.g. a substantially frictionless spool. The roller 2104 may define a flanged end. The bolt 2106 may engage with an end of the roller 2104 opposite to the flanged end after this end is received into the (loop of the) second end of the spring 112. These two ends of the roller 2104 may define terminal portions of the roller 2104. The flanged end may be adapted to the second end of the spring 112 so that the flanged end is prevented from passing through the second end (a loop thereof). The roller 2104 may allow the second end of the spring 112 to slide on the roller 2104 as the arm 1902 is rotated while preventing lateral movement when the roller 2104 is bolted on to the arm 1902 and the second end of the spring 112 is engaged with the roller 2104. In such a manner, lateral movement of the second end of the spring 112 may thereby be resisted (by the spring 112) and/or constrained. In some embodiments, as the second end of the spring 112 slides in such a manner, terminal ends thereof may abut the roller 2104. For example, the motion of the arm 1902 may thereby be resisted (by the spring 112) and/or constrained.

In various embodiments, a plurality of apertures 2108 may be provided on the arm 1902 so as to allow selective engagement of pins, bolts, and/or rollers with the arm 1902. The plurality of apertures 2108 may be spaced apart along the arm 1902. In various embodiments, the plurality of apertures 2108 may be spaced apart along a direction of elongation of the arm 1902 and/or lateral thereto, as shown in FIG. 21B. For example, such selective engagement (between multiple positions of the roller 2104) may allow varying of the constraint and/or resistance applied to the second end of the spring 112 during rotation of the arm 1902 for spring tension adjustment. Advantageously, the response of the arm 1902 to forcing may be adjusted or varied based on cutting needs.

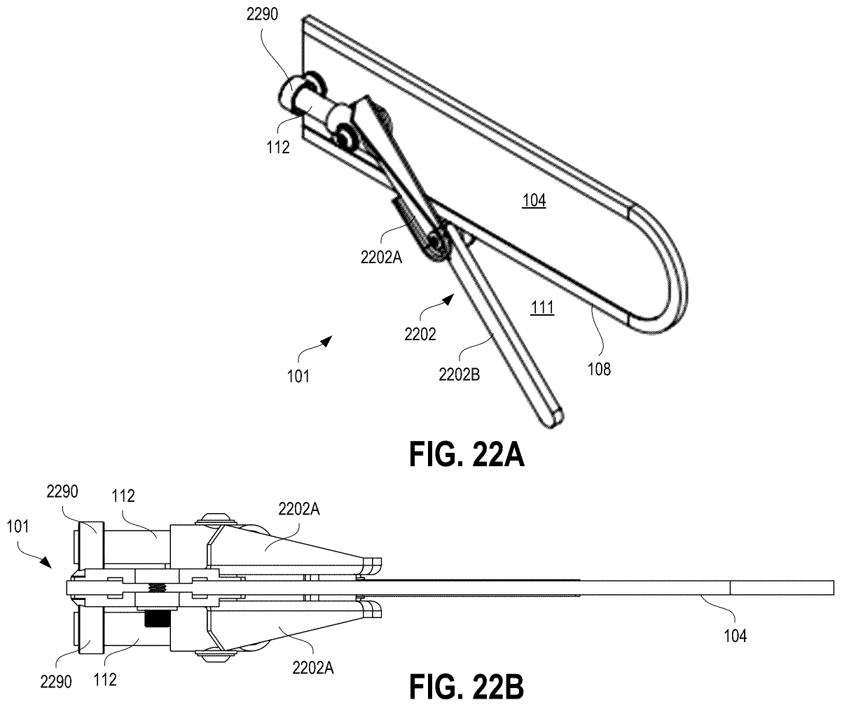

FIG. 22A is a perspective view of an apparatus 101 coupled to a guide 104, in accordance with an embodiment.

FIG. 22B is a top plan view of the apparatus 101 of FIG. 22A, in accordance with an embodiment. In FIGS. 22A-22B, the apparatus comprises springs 112 that is an extension spring or other type of elongated spring. Extension springs may provide a restoring force when bent normal to their direction of elongation, or direction along which such springs are configured to be compressed and/or stretched. The springs 112 in FIGS. 22A-22B may be coupled to the arm 2202 and a guide 104 of the cutting edge 108 such that rotation of the arm 2202 causes bending of the springs 112 to generate a restoring force to return the arm 2202 to the open position. As shown in FIGS. 22A-22B, a corresponding end of each of the springs 112 is coupled for co-rotation with the arm 2202. Another corresponding end of each of the extension springs 112 may be slidably received into a collar 2290 such that rotation of the arm 2202 causes an end of the extension spring 112 to abut the collar 2290 to bend the extension spring 112.

The arm 2202 may be an arm assembly. The arm 2202 may include a first portion 2202A and a second portion 2202B coupled to the cutting device via the first portion 2202A. In various embodiments, the second portion 2202B may define an end of the expandable opening 111. In various embodiments, the first and second portions 2202A, 2202B may be elongated portions of the arm 2202. For example, the first and second portions 2202A, 2202B connected to each other in series may form the full elongation of the arm 2202. It is understood that, in some embodiments, additional portions of the arm 2202 may be disposed between the first and second portions 2202A, 2202B.

In various embodiments, the first portion 2202A may comprise a first sub-portion disposed on a first side of the guide 104 and a second sub-portion disposed on a second side of the guide 104 opposite to the first side, as can be seen in FIG. 22B. In various embodiments, each of the first and second sub-portions may be attached separately to the guide 104 and/or attached to each other via the guide 104 by sandwiching the guide 104 and frictionally engaging therewith. For example, a pin or fastener passing through the guide 104 may attaching the two sub-portions to each other. The first and second sub-portions may be attached (or others rigidly connected) to each other below the guide 104 so as to form a U-shaped first portion 2202A that straddles the guide 104 without contacting the cutting edge 108. One of the springs 112 may be disposed on the first side of the guide 104 and another of the springs 112 may be disposed on the second side of the guide 104. Advantageously, such a configuration may improve rigidity and mitigating undesirable sideways twisting of the arm 2202 under loading to maintain appropriate alignment with the guide 104. Additionally, such a configuration may allow greater spring force to be achieved by application of spring force from two springs in parallel via a single arm.

It is conceived that, in some embodiments, the apparatus 101 may comprise a single spring 112 and a single-sided first portion 2202A.

Advantageously, the second portion 2202B may be offset from the first portion 2202A and may be offset relative to the guide 104 such that the second portion 2202B is centered on a cutting plane defined by the cutting edge 108.

Advantageously, a single arm is sufficient to push against an object positioned in the expandable opening 111. Use of a single arm may improve balance of the system during use, improve ease of assembly, and reduce manufacturing cost.

In various embodiments, the first portion 2202A may be pivotably coupled to the cutting device, and the second portion 2202B may be pivotably coupled to the first portion 2202A. In various embodiments, the first portion 2202A may be positioned proximal to the cutting edge 108 and the second portion 2202B may be positioned distal from the cutting edge 108.

In various embodiments, the first and second portions 2202A, 2202B may be coupled to each other at a position below the cutting edge 108, as shown in FIGS. 22A-22B.

In various embodiments, the second portion 2202B may be configured for one-way rotation about the first portion 2202A. The second portion 2202B may be allowed to rotate about the first portion 2202A towards cutting edge 108 while hindering rotation thereof away from the cutting edge 108.

For example, in some embodiments, a releasable ratchet may couple the first and second portions 2202A, 2202B to achieve one-way rotation of the second portion 2202B about the first portion 2202A. A releasable ratchet may be positioned below the cutting edge 108 such that rotation of the second portion 2202B towards the cutting edge does not lead to interference between the arm 2202 and the cutting edge 108 and/or guide 104.

As the second portion 2202B is rotated towards the cutting edge 108, a ratchet gear of the releasable ratchet may also rotate with a pawl, e.g. a spring-loaded pawl, resting on the ratchet gear to ratchet against teeth of the ratchet gear. As rotation of the cutting edge 108 is stopped and made to reverse, the pawl may engage with the teeth of the ratchet gear to prevent such motion and substantially arrest the second portion 2202B in place. The ratchet may then be released to allow the second portion 2202B to rotate back away from the cutting 108. For example, the ratchet may include a toggle that is engageable to displace the pawl away from the ratchet gear to allow free rotation of the second portion 2202B about the first portion 2202A.

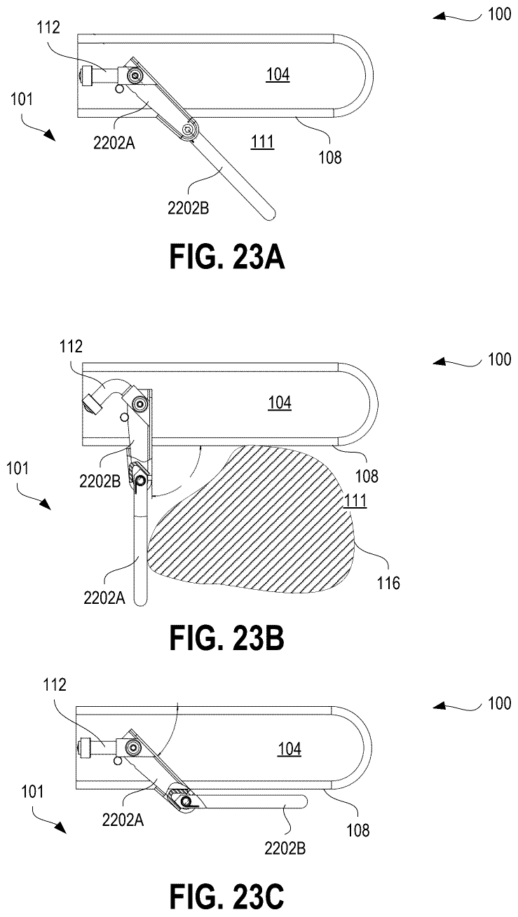

Example operations of the apparatus 101 by rotation of the second portion 2202B about the first portion 2202A are illustrated in FIGS. 23A-23C.

FIG. 23A is a side elevation view of a system 100 with a two-portion arm 2202 in an open position, in accordance with an embodiment.

The open position may be a relaxed position for the springs 112 such that the arm 2202 tends to remain in such position if not disturbed.

FIG. 23B is a side elevation view of the system 100 of FIG. 23A with the two-portion arm 2202 in a wide-open position due to a reaction force applied on to the arm 2202 by an object in the expandable opening 111, in accordance with an embodiment.

As shown in FIG. 23B, the two-portion arm 2202 may be angled at about 90° from the cutting edge 108 when the object 116 is pushed into the opening 111. The first and second portions 2202A, 2202B may be coupled to each other for one-way rotation relative to each other such that the first and second portions 2202A, 2202B remain aligned as the object 116 pushes on to the arm 2202.

In the wide-open position, the springs 112 may be bent so as to generate a restoring force urging the arms 2202 back to the open position.

FIG. 23C is a side elevation view of the system 100 of FIG. 23A with the two-portion arm 2202 retracted into a closed position, in accordance with an embodiment.

In the retracted position, the first portion 2202A may remain in the open position orientation, e.g. a position associated with a relaxed state of the springs 112. In the retracted position, the second portion 2202B is rotated towards the cutting edge 108 and brought in close proximity to the cutting edge 108. Advantageously, the system 100 may then assume a compact form suitable for transportation and for facilitating extraction from a tree canopy, e.g. to prevent snagging on tree branches. A one-way rotation mechanism associated with the second portion 2202B may be suitably configured to mitigate interference between the second portion 2202B and the cutting edge 108 when the second portion 2202B assumes the retracted position and when the second portion 2202B receives an impact, directed at least partially towards the cutting edge, in such a retracted position.

In some embodiments, the device shown in FIGS. 22, 23A-23C may include a wheel connected to the second portion 2202B of the arm 2202 to facilitate cutting.

In FIGS. 23A-23C, the cutting device, save for the guide 104, is omitted for clarity.

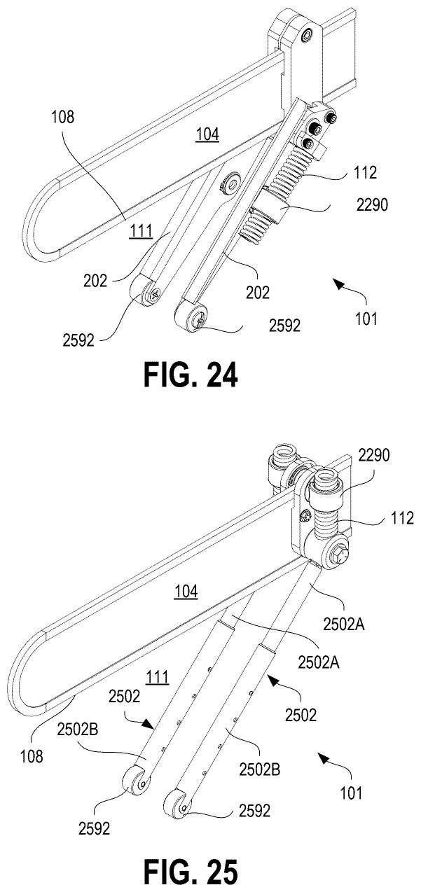

FIG. 24 is a perspective view of an apparatus 101 for cutting objects, in accordance with an embodiment.

In the embodiment shown in FIG. 24, wheels 2592 are disposed at ends of the (two) arms 102. The wheels may be disposed at terminal ends of the arms 102 and may be so positioned to allow rolling thereof against an object during approach of an object being cut towards the opening 111 and its retraction away from the opening 111.

As in the embodiment of FIGS. 22A-22B, the embodiment in FIG. 25 comprises a collar 2290 suitable to receive therein a spring 112 such as an extensional spring.

FIG. 25 is a perspective view of an apparatus 101 for cutting objects, in accordance with another embodiment.

In the embodiment shown in FIG. 25, the apparatus comprising two arms 2502 coupled to the guide 104. The arms 2502 may be telescoping arms configured to allow selective lengthening and shortening of the arms 2502. Each arm 2502 includes a first tubular portion 2502A and a second tubular portion 2502B. Such tubular portions may be releasably coupled to each other, e.g. by means of a removable or disengageable detent, or pin. The first tubular portion 2502A may be disposed in the second tubular portion. The arm 2502 may be lengthened by telescoping of the first and second tubular portions 2502A, 2502B relative to each other.

As shown in FIG. 25, the first tubular portion 2502A may be disposed inside the second tubular portion 2502B for slidable engagement of the first tubular portion 2502A inside the second tubular portion 2502B. The second tubular portion 2502B may include a plurality of apertures suitable to receive an extension, such as a pin, extending from the first tubular portion 2502A so couple the first and second tubular portions 2502A, 2502B to each other.

Embodiments can include combinations of features described herein. For example, a cutting device may be pivotably coupled to arms, and may also be coupled to the arms with both torsion and linear springs so as to provide resistance to rotation of the arms about the pivot.

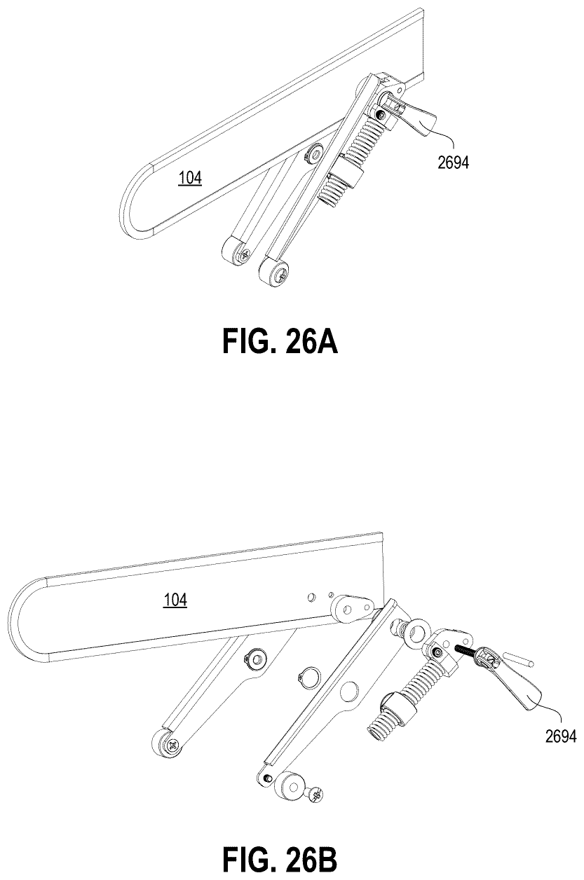

FIG. 26A is a perspective view of an apparatus 101, in accordance with an embodiment.

FIG. 26B is an exploded perspective view of the apparatus 101 of FIG. 26A, in accordance with an embodiment.

The embodiments in FIG. 26A, 26B comprise a handle 2694 that may allow a quick release of the apparatus from the guide 104. A user may engage the handle 2694 to rapidly remove the apparatus from the cutting device. The handle 2694 may be a handle of a quick release or quick disconnect mechanism.

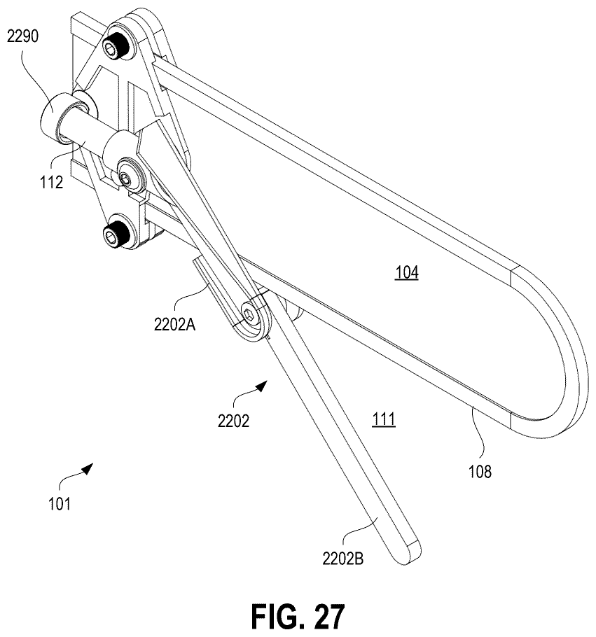

FIG. 27 is a perspective view of an apparatus 101, in accordance with yet another embodiment.

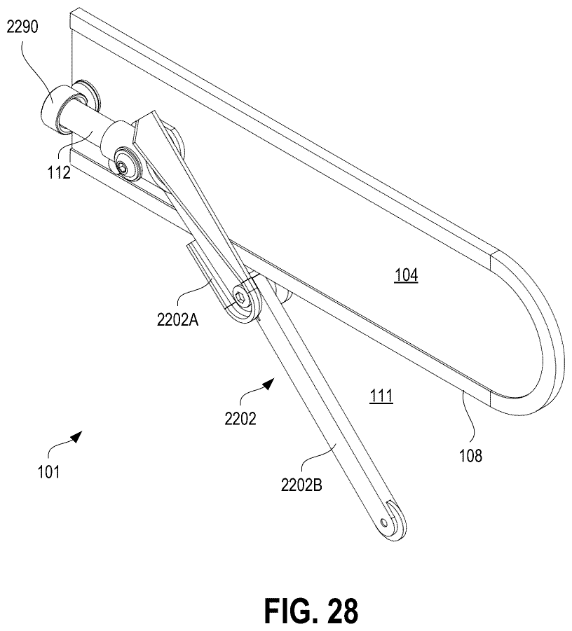

FIG. 28 is a perspective view of an apparatus 101, in accordance with a further embodiment.

The embodiments in FIGS. 27-28 may be substantially similar to that in FIG. 22, 23A-23C.

The embodiment in FIG. 27 includes a bracket attached to the guide 104 to facilitate attachment of the collar 2290, the springs 112, and the arm 2202 to the guide 104.

The embodiment in FIG. 28 may further include a wheel disposed at a terminal end of the arm 2202. The wheel may be substantially narrower than a width of the arm 2202 so as to not jut out from the side of the arm 2202. In some embodiments, the wheel may about as wide as the arm 2202. It is conceived that, in some embodiments, the arm 2202 of the embodiment shown in FIG. 27 may include a wheel. As can be understood, the examples described above and illustrated are intended to be exemplary only.

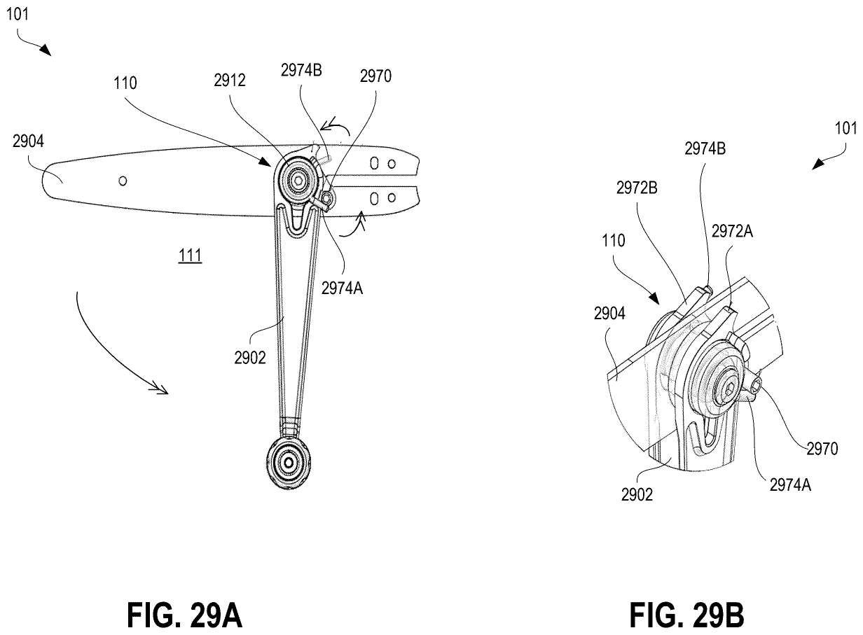

FIG. 29A is a side elevation view of an apparatus 101 moving into an open state, in accordance with yet another embodiment.

FIG. 29B is an enlarged perspective view of the apparatus 101 in FIG. 29A.

The movement that moves the apparatus 101 into an open state is indicated in FIGS. 29A-29B by double-chevron arrows.

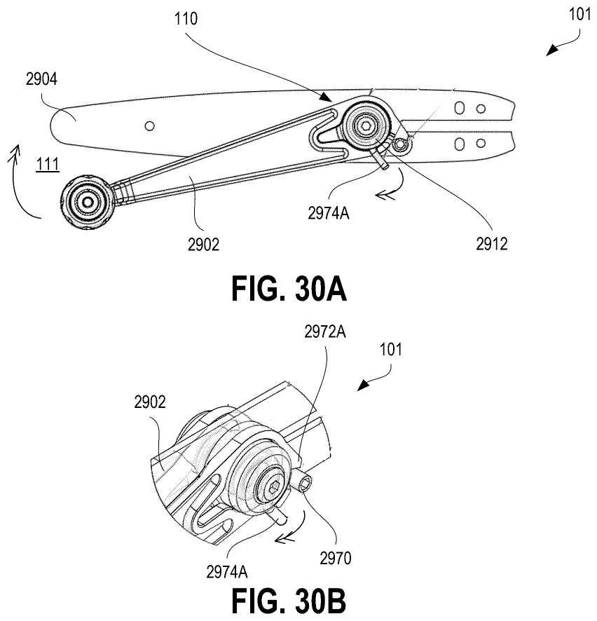

FIG. 30A is a side elevation view of the apparatus 101 of FIG. 29A moving into a closed state, in accordance with an embodiment.

FIG. 30B is an enlarged perspective view of the apparatus 101 in FIG. 30A.

The movement that moves the apparatus 101 into a closed state is indicated in FIGS. 29A-29B by double-chevron arrows.

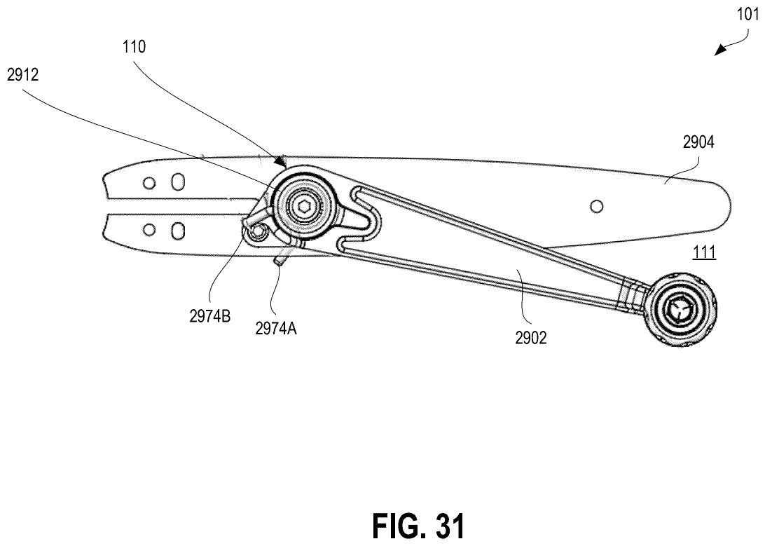

FIG. 31 is a side elevation view of the apparatus 101 in FIG. 30A from an opposite side of the guide 2904, in accordance with an embodiment.

Referring to FIGS. 29A-29B, 30A-30B, 31, the apparatus 101 comprises an arm 2902 coupled to a guide 2904 via a double-action torsion spring 2912. The double-action torsion spring 2912 defines a pair of tangs 2974A, 2974B. The tangs 2974A, 2974B may define opposite (terminal) ends of the double-action torsion spring 2912 and may extend away from each other and from a central body of the double-action torsion spring 2912. The central body of the double-action torsion spring 2912 may define a coil for generating a spring force when the pair of tangs 2974A, 2974B are pushed or rotated away from each other (or in opposite directions), e.g. by holding one tang stationary and pushing the other one away. The views in FIGS. 29A-29B, 30A-30B, 31 are partially transparent to illustrate the double-action torsion spring 2912.

Referring to FIGS. 29B, 30B, the arm 2902 is coupled to the guide 2904 on opposite sides of the guide 2904. For example, the arm 2902 may comprise two coupling components disposed on opposite sides of the guide 2904 and connected to each other via a slot or aperture formed in the guide 2904 between the coupling components.

Referring to FIGS. 29A-29B, 30A-30B, 31, the arm 2902 is pivotably coupled to the guide 2904 about the pivot point 110. The double-action torsion spring 2912 is coupled to rotate with the arm 2902, relative to the guide 2904, and is positioned so that its opposite ends are disposed on opposite sides of the guide 2904. As such, the tangs 2974A, 2974B are disposed on opposite sides of the guide 2904. The central body of the double-action torsion spring 2912 may be at least partially disposed in a slot extending through the guide 2904.

In some embodiments, the arm 2902 may comprise two independent arms disposed on opposite sides of the guide 2904 and coupled to each other and the guide 2904 via a slot in the guide 2904 and the double-action torsion spring 2912.

The arm 2902 defines rotating stops 2972A, 2972B that are spaced apart from the tangs 2974A, 2974B and are configured to rotate with the arm 2902. The rotating stops 2972A, 2972B are disposed on opposite sides of the arm 2902.

A stationary stop 2970 is positioned adjacent to the arm 2902 and extends on both sides of the guide 2904 to allow the tangs 2974A, 2974B and the rotating stops 2972A, 2972B to abut the stationary stop 2970 as the arm 2902 is rotated back and forth, i.e. between an open and closed positions. In various embodiments, the stationary stop 2970 may be a pin. The pin may extend through the guide 2904 on either side thereof to provide a stationary surface for abutment. Such a surface may be substantially rounded or cylindrical. The pin may be fixedly attached to the guide 2904.

For example, FIG. 29B shows the tang 2974A abutting the stationary stop 2970 when the arm 2902 is opened, i.e. moved away from the guide 2904. For example, FIG. 30B shows the rotating stop 2972A abutting the stationary stop 2970 when the arm 2902 is closed, i.e. moved toward the guide 2904.

Referring to FIG. 30A, 31, the tangs 2974A, 2972B are (non-changeably) disposed or positioned on opposite sides of the stationary stop 2970. In particular, the tang 2974A is positioned below the stationary stop 2970 so that the tang 2974A abuts the stationary stop 2970 when the arm 2902 is rotated down, i.e. moved towards an open state. On the other hand, the tang 2974B is positioned above the stationary stop 2970 so that the tang 2974B abuts the stationary stop 2970 when the arm is rotated up, i.e. moved towards a closed state.

When the either of the tangs 2974A, 2974B abut the stationary stop, the double-action torsion spring 2912 is deformed (wound up) and a restoring (torsion) force is generated that flexibly or adjustably opposes further movement of the arm 2902 in the direction of continued engagement of the abutting tang with the stationary stop 2970. Advantageously, resilient coupling of the arm 2902 to the guide 2904 may achieved efficiently and in a relatively compact form.

Advantageously, the double-action torsion spring 2912 may allow for the apparatus 101 and its arm 2902 to move through its entire range of motion without reversing the double-action torsion spring's 2912 rotation.

For example, reverse rotation of torsion springs may be avoided. This is advantageous because reverse rotation is found to put unacceptably high stresses on the spring, which may lead to early failure.

Advantageously, embodiments disclosed herein, e.g. those of FIGS. 29A-29B, are able to cut very close to trunks of trees, known as flush cuts or branch collar cuts. This ability is afforded by the reduction of bulk in the overall design, which may allow for the apparatus 101 to be positioned relatively closer to the chain bar. With ¼ inch.

The embodiments described in this document provide non-limiting examples of possible implementations of the present technology. Upon review of the present disclosure, a person of ordinary skill in the art will recognize that changes may be made to the embodiments described herein without departing from the scope of the present technology. For example, various other types of cutting devices may be used, the arms may be arcuate, rectangular, or other shapes, additional springs may be provided for additional resiliency, the arms may be extended in multiple directions and may be textured to receive objects, the arms may be resiliently coupled via resilient (spring) elements positioned below, above, or at a level of the guide, and the resilient elements may be constructed of a metal, fabric (e.g. as in a bungee cord), and/or resilient plastic. Yet further modifications could be implemented by a person of ordinary skill in the art in view of the present disclosure, which modifications would be within the scope of the present technology.

What is claimed is:

1. A system for cutting an object, comprising:
a cutting device defining a cutting edge; and
an arm coupled to the cutting device to be resiliently rotatable away from the cutting edge and biased in an open position, the arm being angled away from the cutting edge in the open position to define, between the cutting edge and the arm, an expandable opening that is suitable to receive the object and to expand by pushing of the object on to the arm to rotate the arm away from the cutting edge as the object is drawn into the opening to urge the object against the cutting edge.

2. The system of claim 1, wherein the arm is coupled to the cutting device via a spring that is in a relaxed state in the open position to keep the arm spaced away from the cutting edge in the open position.

3. The system of any one of claims 1 and 2, wherein the arm rotates away from the cutting edge about a pivot such that drawing the object into the opening by drawing the object towards the pivot expands the opening.

4. The system of any one of claims 1 to 3, further comprising a clamp that is clamped to a guide of the cutting edge and an end pivotably coupled to the arm.

5. The system of any one of claims 1 to 4, further comprising an extension spring coupled to the arm and a guide of the cutting edge such that rotation of the arm causes bending of the extension spring to generate a restoring force to return the arm to the open position.

6. The system of claim 5, wherein the extension spring is slidably received into a collar such that rotation of the arm causes an end of the extension spring to abut the collar to bend the extension spring.

7. The system of any one of claims 1 to 6, further comprising an extension spring coupled to the arm and a guide of the cutting edge such that rotation of the arm causes bending of the extension spring to generate a restoring force to return the arm to the open position, wherein the extension spring is received into the collar for free slidable rotation within the collar.

8. The system of any one of claims 1 to 6, wherein the arm is angled at least 45° away from the cutting edge in the open position.

9. The system of any one of claims 1 to 8, wherein a portion of the arm defining an end of the opening is centered on a cutting plane defined by the cutting edge.

10. The system of any one of claims 1 to 9, wherein the system further comprises a boom coupled to the cutting device.

11. The system of any one of claims 1 to 10, wherein the cutting device includes a motor configured to cause cutting of the object via the cutting edge, the system further comprising:
a sensor to sense data indicative of motor power of the motor;
an actuator coupled to the arm to rotate the arm towards and away from the cutting edge; and
a controller configured to receive the data from the sensor and operably coupled to the actuator, the controller configured to control rotation of the arm in response to the data to control urging of the object against the cutting edge.

12. The system of claim 11, wherein the controller includes a processor; and
computer-readable memory coupled to the processor and storing processor-executable instructions that, when executed, configure the processor to:
receive the data during cutting; and
control the arm opposite to the object based on the data to mitigate motor loading.

13. The system of any one of claims 1 to 12, wherein the cutting device is a chainsaw, a cutting chain being mounted on a peripheral edge of a guide of the cutting edge.

14. The system of any one of claims 1 to 13, wherein the cutting device is a brush cutter.

15. The system of any one of claims 1 to 14, wherein the arm includes:
a first portion pivotably coupled to the cutting device and positioned proximal to the cutting edge; and
a second portion pivotably coupled to the first portion and positioned distal from the cutting edge, the second portion coupled to the cutting device via the first portion.

16. The system of claim 15, wherein the second portion is configured for one-way rotation about the first portion to allow rotation of the second portion, about the first portion, towards the cutting edge and to hinder rotation of the second portion, about the first portion, away from the cutting edge.

17. The system of any one of claims 1 to 16, wherein the arm includes a roller disposed at a terminal end of the arm.

18. The system of any one of claims 1 to 17, wherein the arm includes a first tubular portion disposed in a second tubular portion, the arm is suitable to lengthened by telescoping of first and second tubular portions relative to each other.

19. The system of any one of claims 1 to 18, wherein the arm is releasably attached to the cutting device.

20. The system of any one of claims 1 to 19, wherein the arm is coupled to the cutting device via an actuator configured to cause resilient rotation of the arm towards and away from the cutting edge.

21. The system of any one of claims 1 to 20, wherein the arm includes a wheel disposed at a terminal end of the arm distal from the cutting device to allow rolling of the wheel against the object as the object is received into the opening.

22. The system of any one of claims 1 to 21, wherein the arm is a first arm, the system further comprising a second arm coupled to the cutting device to be resiliently rotatable away from the cutting edge and spaced apart from the first arm to sandwich the cutting edge in-between the first arm and the second arm, the first and second arms suitable to urge the object against the cutting edge as the object is drawn into the opening.

23. An apparatus for cutting an object using a cutting device defining a cutting edge, comprising:
an arm; and
a coupler coupled to the arm and suitable to be mounted to the cutting device to allow resilient rotation of the arm away from the cutting edge and to bias the arm in an open position, the coupler configured to angle the arm away from the cutting edge in the open position to define, between the cutting edge and the arm, an expandable opening that is suitable to receive the object and to expand by pushing of the object on to the arm to rotate the arm away from the cutting edge as the object is drawn into the opening to urge the object against the cutting edge.

24. The apparatus of claim 23, wherein the coupler is configured to couple the arm to the cutting device via a spring that is configured to be in a relaxed state in the open position to keep the arm spaced away from the cutting edge in the open position.

25. The apparatus of any one of claims 23 and 24, wherein the arm, when coupled to the cutting device via the coupler, is configured to rotate away from the cutting edge about a pivot such that drawing the object into the opening by drawing the object towards the pivot expands the opening.

26. The apparatus of any one of claims 23 to 25, wherein the coupler further comprises a clamp configured to be clamped to a guide of the cutting edge and an end pivotably coupled to the arm.

27. The apparatus of any one of claims 23 to 26, wherein the coupler further comprises an extension spring coupled to the arm and configured to be coupled to a guide of the cutting edge such that rotation of the arm, when coupled to the cutting device via the coupler, causes bending of the extension spring to generate a restoring force to return the arm to the open position.

28. The apparatus of claim 27, wherein the extension spring is configured to be slidably received into a collar such that rotation of the arm, when coupled to the cutting device, causes an end of the extension spring to abut the collar to bend the extension spring.

29. The apparatus of any one of claims 23 to 28, wherein the coupler further comprises an extension spring coupled to the arm and configured to be coupled to a guide of the cutting edge such that rotation of the arm causes bending of the extension spring to generate a restoring force to return the arm to the open position, wherein the extension spring is received into the collar for free slidable rotation within the collar.

30. The apparatus of any one of claims 23 to 28, wherein the arm, when coupled to the cutting device via the coupler, is configured to be angled at least 45° away from the cutting edge in the open position.

31. The apparatus of any one of claims 23 to 30, wherein the arm, when coupled to the cutting device via the coupler, is configured such that a portion of the arm defining an end of the opening is centered on a cutting plane defined by the cutting edge.

32. The apparatus of any one of claims 23 to 31, wherein the cutting device includes a motor configured to cause cutting of the object via the cutting edge, the apparatus further comprising:
an actuator configured to be coupled to the arm to rotate the arm, when coupled to the cutting device, towards and away from the cutting edge; and
a controller configurable to receive data from a sensor and suitable to be operably coupled to the actuator, the sensor configured to sense data indicative of motor power of the motor, the controller configured to control rotation of the arm, when coupled to the cutting device, in response to the data to control urging of the object against the cutting edge.

33. The apparatus of claim 32, wherein the controller includes
a processor; and
computer-readable memory coupled to the processor and storing processor-executable instructions that, when executed, configure the processor to:
receive the data during cutting; and
control the arm opposite to the object based on the data to mitigate motor loading.

34. The apparatus of any one of claims 23 to 33, wherein the cutting device is a chainsaw, a cutting chain being mounted on a peripheral edge of a guide of the cutting edge.

35. The apparatus of any one of claims 23 to 34, wherein the cutting device is a brush cutter.

36. The apparatus of any one of claims 23 to 35, wherein the arm includes:
a first portion configured to be pivotably coupled to the cutting device proximal to the cutting edge via the coupler; and
a second portion pivotably coupled to the first portion to be positioned distal from the cutting edge when the first portion is coupled to the cutting device, the second portion suitable to be coupled to the cutting device via the first portion.

37. The apparatus of claim 36, wherein the second portion is configured for one-way rotation about the first portion.

38. The apparatus of any one of claims 23 to 37, wherein the arm includes a roller disposed at a terminal end of the arm.

39. The apparatus of any one of claims 23 to 38, wherein the arm includes a first tubular portion disposed in a second tubular portion, the arm is suitable to lengthened by telescoping of first and second tubular portions relative to each other.

40. The apparatus of any one of claims 23 to 39, wherein the coupler is configured to releasably attach the arm to the cutting device.

41. The apparatus of any one of claims 23 to 40, wherein the coupler further comprises an actuator configured to couple the cutting device to the arm to cause resilient rotation of the arm towards and away from the cutting edge.

42. The apparatus of any one of claims 23 to 41, wherein the arm includes a wheel disposed at a terminal end of the arm distal from the cutting device to allow rolling of the wheel against the object when the object is received into the opening.

43. The apparatus of any one of claims 23 to 42, wherein the arm is a first arm, and the coupler is a first coupler, the apparatus further comprising a second arm configured to be coupled to the cutting device via a second coupler to be resiliently rotatable away from the cutting edge and, when coupled to the cutting device via the second coupler, configured to be spaced apart from the first arm to sandwich the cutting edge in-between the first arm and the second arm, the first and second arms suitable to urge the object against the cutting edge as the object is drawn into the opening.

44. A kit for cutting an object using a cutting device defining a cutting edge, comprising:
an arm; and
a coupler to couple the arm to the cutting device to allow resilient rotation of the arm away from the cutting edge and to bias the arm in an open position when the arm is coupled to the cutting device via the coupler, the coupler configured to angle the arm away from the cutting edge in the open position to define, between the cutting edge and the arm, an expandable opening that is suitable to receive the object and to expand by pushing of the object on to the arm to rotate the arm away from the cutting edge as the object is drawn into the opening to urge the object against the cutting edge.

45. The kit of claim 44, wherein the coupler is configured to couple the arm to the cutting device via a spring that is configured to be in a relaxed state in the open position to keep the arm spaced away from the cutting edge in the open position.

46. The kit of any one of claims 44 and 45, wherein the arm, when coupled to the cutting device via the coupler, is configured to rotate away from the cutting edge about a pivot such that drawing the object into the opening by drawing the object towards the pivot expands the opening.

47. The kit of any one of claims 44 to 46, wherein the coupler further comprises a clamp configured to be clamped to a guide of the cutting edge and an end pivotably coupled to the arm.

48. The kit of any one of claims 44 to 47, wherein the coupler further comprises an extension spring configured to be coupled to the arm and a guide of the cutting edge such that rotation of the arm, when coupled to the cutting device via the coupler, causes bending of the extension spring to generate a restoring force to return the arm to the open position.

49. The kit of claim 48, wherein the extension spring is configured to be slidably received into a collar such that rotation of the arm, when coupled to the cutting device, causes an end of the extension spring to abut the collar to bend the extension spring.

50. The kit of any one of claims 44 to 49, wherein the coupler further comprises an extension spring configured to be coupled to the arm and to a guide of the cutting edge such that rotation of the arm causes bending of the extension spring to generate a restoring force to return the arm to the open position, wherein the extension spring is received into the collar for free slidable rotation within the collar.

51. The kit of any one of claims 44 to 49, wherein the arm, when coupled to the cutting device via the coupler, is configured to be angled at least 45° away from the cutting edge in the open position.

52. The kit of any one of claims 44 to 51, wherein the arm, when coupled to the cutting device via the coupler, is configured such that a portion of the arm defining an end of the opening is centered on a cutting plane defined by the cutting edge.

53. The kit of any one of claims 44 to 52, wherein the cutting device includes a motor configured to cause cutting of the object via the cutting edge, the kit further comprising:
an actuator configured to be coupled to the arm to rotate the arm, when coupled to the cutting device, towards and away from the cutting edge; and
a controller configurable to receive data from a sensor and suitable to be operably coupled to the actuator, the sensor configured to sense data indicative of motor power of the motor, the controller configured to control rotation of the arm, when coupled to the cutting device, in response to the data to control urging of the object against the cutting edge.

54. The kit of claim 53, wherein the controller includes
a processor; and
computer-readable memory coupled to the processor and storing processor-executable instructions that, when executed, configure the processor to:
receive the data during cutting; and
control the arm opposite to the object based on the data to mitigate motor loading.

55. The kit of any one of claims 44 to 54, wherein the cutting device is a chainsaw, a cutting chain being mounted on a peripheral edge of a guide of the cutting edge.

56. The kit of any one of claims 44 to 55, wherein the cutting device is a brush cutter.

57. The kit of any one of claims 44 to 56, wherein the arm includes:
a first portion configured to be pivotably coupled to the cutting device proximal to the cutting edge via the coupler; and
a second portion suitable to be pivotably coupled to the first portion so to be positioned distal from the cutting edge when the first portion is coupled to the cutting device, the second portion suitable to be coupled to the cutting device via the first portion.

58. The kit of claim 57, wherein the second portion is configured for one-way rotation about the first portion.

59. The kit of any one of claims 44 to 58, wherein the arm includes a roller disposed at a terminal end of the arm.

60. The kit of any one of claims 44 to 59, wherein the arm includes a first tubular portion disposed in a second tubular portion, the arm is suitable to lengthened by telescoping of first and second tubular portions relative to each other.

61. The kit of any one of claims 44 to 60, wherein the coupler configured to releasably attach the arm to the cutting device.

62. The kit of any one of claims 44 to 61, wherein the coupler further comprises an actuator configured to couple the cutting device to the arm to cause resilient rotation of the arm towards and away from the cutting edge.

63. The kit of any one of claims 44 to 62, wherein the arm includes a wheel disposed at a terminal end of the arm distal from the cutting device to allow rolling of the wheel against the object when the object is received into the opening.

64. The kit of any one of claims 44 to 63, wherein the arm is a first arm, and the coupler is a first coupler, the kit further comprising a second arm configured to be coupled to the cutting device and the first arm via a second coupler to be resiliently rotatable away from the cutting edge and, when coupled to the cutting device via the second coupler, configured to be spaced apart from the first arm to sandwich the cutting edge in-between the first arm and the second arm, the first and second arms suitable to urge the object against the cutting edge as the object is drawn into the opening.

65. An apparatus for cutting an object using a cutting device defining a cutting edge, comprising:
an arm; and
a means for mounting the arm to the cutting device to allow resilient rotation of the arm away from the cutting edge and to bias the arm in an open position, wherein the arm is angled away from the cutting edge in the open position to define, between the cutting edge and the arm, an expandable opening that is suitable to receive the object, and the arm rotates away from the cutting edge as the object is drawn into the opening to expand the opening and to urge the object against the cutting edge.

66. The apparatus of claim 65, wherein the means includes a spring that is configured to be in a relaxed state in the open position to keep the arm spaced away from the cutting edge in the open position.

67. The apparatus of any one of claims 65 and 66, wherein the arm, when mounted to the cutting device, is configured to rotate away from the cutting edge about a pivot such that drawing the object into the opening by drawing the object towards the pivot expands the opening.

68. The apparatus of any one of claims 65 to 67, wherein the means includes a clamp configured to be clamped to a guide of the cutting edge and an end pivotably coupled to the arm.

69. The apparatus of any one of claims 65 to 68, wherein the means includes an extension spring coupled to the arm and configured to be coupled to a guide of the cutting edge such that rotation of the arm, when coupled to the cutting device, causes bending of the extension spring to generate a restoring force to return the arm to the open position.

70. The apparatus of claim 69, wherein the extension spring is configured to be slidably received into a collar such that rotation of the arm, when coupled to the cutting device, causes an end of the extension spring to abut the collar to bend the extension spring.

71. The apparatus of any one of claims 65 to 70, wherein the means includes an extension spring coupled to the arm and configured to be coupled to a guide of the cutting edge such that rotation of the arm causes bending of the extension spring to generate a restoring force to return the arm to the open position, wherein the extension spring is received into the collar for free slidable rotation within the collar.

72. The apparatus of any one of claims 65 to 71, wherein the arm, when mounted to the cutting device, is configured to be angled at least 45° away from the cutting edge in the open position.

73. The apparatus of any one of claims 65 to 72, wherein the arm, when mounted to the cutting device, is configured such that a portion of the arm defining an end of the opening is centered on a cutting plane defined by the cutting edge.

74. The apparatus of any one of claims 65 to 73, wherein the cutting device includes a motor configured to cause cutting of the object via the cutting edge, the apparatus further comprising:
an actuator configured to be coupled to the arm to rotate the arm, when coupled to the cutting device, towards and away from the cutting edge; and
a controller configurable to receive data from a sensor and suitable to be operably coupled to the actuator, the sensor configured to sense data indicative of motor power of the motor, the controller configured to control rotation of the arm, when coupled to the cutting device, in response to the data to control urging of the object against the cutting edge.

75. The apparatus of claim 74, wherein the controller includes
a processor; and
computer-readable memory coupled to the processor and storing processor-executable instructions that, when executed, configure the processor to:
receive the data during cutting; and
control the arm opposite to the object based on the data to mitigate motor loading.

76. The apparatus of any one of claims 65 to 75, wherein the cutting device is a chainsaw, a cutting chain being mounted on a peripheral edge of a guide of the cutting edge.

77. The apparatus of any one of claims 65 to 76, wherein the cutting device is a brush cutter.

78. The apparatus of any one of claims 65 to 77, wherein the arm includes:
a first portion configured to be pivotably coupled to the cutting device proximal to the cutting edge; and
a second portion pivotably coupled to the first portion to be positioned distal from the cutting edge when the first portion is coupled to the cutting device, the second portion suitable to be coupled to the cutting device via the first portion.

79. The apparatus of claim 78, wherein the second portion is configured for one-way rotation about the first portion.

80. The apparatus of any one of claims 65 to 79, wherein the arm includes a roller disposed at a terminal end of the arm.

81. The apparatus of any one of claims 65 to 80, wherein the arm includes a first tubular portion disposed in a second tubular portion, the arm is suitable to lengthened by telescoping of first and second tubular portions relative to each other.

82. The apparatus of any one of claims 65 to 81, wherein the means allows releasable attachment of the arm to the cutting device.

83. The apparatus of any one of claims 65 to 82, wherein the means includes an actuator configured to couple the cutting device to the arm to cause resilient rotation of the arm towards and away from the cutting edge.

84. The apparatus of any one of claims 65 to 83, wherein the arm includes a wheel disposed at a terminal end of the arm distal from the cutting device to allow rolling of the wheel against the object when the object is received into the opening.

85. The apparatus of any one of claims 65 to 84, wherein the arm is a first arm, and the means is a first means, the apparatus further comprising a second arm configured to be coupled to the cutting device via a second means to be resiliently rotatable away from the cutting edge and, when mounted to the cutting device, configured to be spaced apart from the first arm to sandwich the cutting edge in-between the first arm and the second arm, the first and second arms suitable to urge the object against the cutting edge as the object is drawn into the opening.

86. A cutting system, comprising:
a first cutting device defining a first cutting edge for cutting a first object;
an apparatus according to any one of claims 65 to 85, wherein the cutting device is the first cutting device, the cutting edge is the first cutting edge, and the object is the first object.

87. A kit for forming the apparatus of any one of claims 65 to 85.
